(19) United States
(12) Patent Application Publication
(10) Pub. No.: US 2026/0169659 A1
(43) Pub. Date: Jun. 18, 2026

(54) NON-VOLATILE PERSISTENT VIRTUAL MEMORY WITH DYNAMIC PAGING FOR DECENTRALIZED SYSTEMS

(71) Applicant: Lyquor Labs, Inc., San Francisco, CA (US)

(72) Inventors: Maofan YIN, San Francisco, CA (US); Lizan ZHOU, San Francisco, CA (US); Hao HAO, Los Altos, CA (US)

(21) Appl. No.: 19/394,858

(22) Filed: Nov. 19, 2025

Related U.S. Application Data
(60) Provisional application No. 63/722,944, filed on Nov. 20, 2024.
(60) Provisional application No. 63/830,597, filed on Jun. 26, 2025.

(51) Int. Cl. G06F 3/06

(52) U.S. Cl. CPC G06F 3/0664; G06F 3/0611; G06F 3/0673

(57) ABSTRACT

Approaches are described for a decentralized computing platform that enables dynamic execution of distributed services through a hybrid on-chain and off-chain architecture. The platform consists of a network of nodes, each running a virtual machine to host and execute service instances. A sequencer component records, sequences, and notarizes function calls to maintain a consistent service-level state across the network. Computation takes place off-chain on nodes that participate dynamically in specific services based on resource availability. A persistent virtual memory structure manages both service-level and instance-level state. The service-level state is synchronized across nodes participating in the same service, while the instance-level state is isolated to individual nodes for independent operations. The memory system is non-volatile, retaining state across function calls and enabling direct execution from memory. A universal procedure call (UPC) framework facilitates decentralized communication through multicast-enabled operations with customizable fault tolerance and supports applications from finance to high-performance computing.

### CROSS-REFERENCE TO RELATED APPLICATIONS

This application claims the priority benefit of U.S. Provisional Patent Application No. 63/722,944, filed on Nov. 20, 2024, and U.S. Provisional Patent Application No. 63/830,597, filed on Jun. 26, 2025, each of which is hereby incorporated by reference in its entirety.

### BACKGROUND

With the increasing adoption of blockchain technologies, decentralized platforms have gained popularity for enabling transparent, secure, and tamper-resistant transactions. Traditional blockchain networks, such as Bitcoin and Ethereum, rely on consensus mechanisms to achieve trust and agreement across a distributed network of nodes. These mechanisms enforce that all transactions are validated without the need for centralized authorities while offering high levels of security and immutability. While these systems provide high levels of security, they often face significant challenges related to scalability, latency, and computational inefficiency. In these traditional networks, every node must replicate and validate the same set of transactions, which leads to computational inefficiencies and increased time to process each block. As a result, latency grows and throughput decreases, which makes it difficult for the platforms to handle complex, real-time applications that require high-frequency operations and rapid transaction finality. These performance bottlenecks restrict the practical use of decentralized platforms in industries such as finance, gaming, and AI-powered services, where responsiveness and scalability are critical for performance and user experience.

### BRIEF DESCRIPTION OF THE DRAWINGS

Various embodiments in accordance with the present disclosure will be described with reference to the drawings, in which:

FIG. 1 illustrates an example decentralized environment, according to at least one embodiment;

FIG. 2A illustrates an example embodiment of a fate-constrained ordering (FCO) system, according to at least one embodiment;

FIG. 2B illustrates an example coordination and scheduling routine implementing the FCO mechanism, according to at least one embodiment;

FIG. 3 illustrates an example embodiment of memory management within a node running multiple services, in accordance with one disclosed embodiment;

FIG. 4 illustrates an example process for handling dynamic paging through a userspace paging module, according to at least one embodiment;

FIG. 5 illustrates an example embodiment of a universal procedure call (UPC) management system, according to at least one embodiment;

FIG. 6 illustrates a flowchart depicting an example process by which a decentralized platform coordinates transaction processing across a network of nodes, according to at least one embodiment;

FIG. 7 illustrates a flowchart depicting the process of executing decentralized services and managing persistent virtual memory across a network of nodes, according to at least one embodiment;

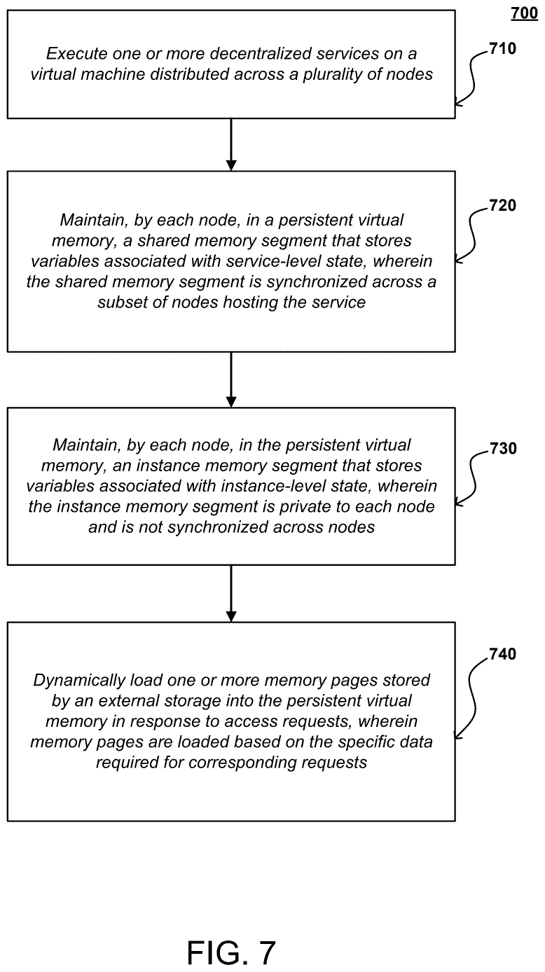

FIG. 8 depicts a flowchart illustrating using a universal procedure call (UPC) to facilitate multicast-enabled communication between nodes, according to at least one embodiment; and

FIG. 9 illustrates an example computer system, according to at least one embodiment.

### DETAILED DESCRIPTION

### Summary

In the following description, various embodiments will be described. For purposes of explanation, specific configurations, and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Approaches in accordance with embodiments of the present disclosure relate to a decentralized computing platform that facilitates efficient execution of hybrid on-chain and off-chain operations by decoupling transaction sequencing from computation. Through such a platform, nodes may selectively host and execute services based on their resources and capabilities and, therefore, eliminate the need for full replication across the network. A sequencing component (e.g., sequencer) may manage the ordering and notarization of function calls across the network. Each decentralized service can define its own governance logic and select its own sequencer. Instead of relying on a monolithic chain to handle sequencing for all transactions, developers of individual services may configure the necessary logic and incentives to attract nodes to participate in their specific service. This allows nodes to subscribe only to services aligned with their hardware capabilities and interests, which significantly reduces computational overhead and improves scalability.

A decentralized computing platform, in accordance with the present disclosure, may also incorporate a persistent virtual memory system (e.g., LyteMemory), which manages both shared service-level state across multiple nodes and private instance-level state local to each node. Service-level state maintains global variables, such as account balances, transaction history, or service parameters, that remain synchronized across all participating nodes to ensure a consistent view of the service's operations. Instance-level state stores node-specific data such as session caches, intermediate results, or node-local parameters, which do not need to be synchronized across the network. This split between service-level and instance-level state not only improves performance by reducing unnecessary synchronization but also enhances privacy, as sensitive or intermediate data remains isolated to the nodes performing the relevant computations. The persistent virtual memory may further incorporate dynamic memory loading techniques to load relevant data only when required. Such a persistent virtual memory system eliminates the overhead typically associated with serializing and deserializing state data accessed by each transaction, as is commonly seen with existing virtual machines like the Ethereum Virtual Machine (EVM). Instead, a persistent virtual memory system can dynamically swap in and patch pages of data into the process memory of the host RAM when needed such that the service state and instance state are readily available without costly state translations. On the other hand, in traditional cloud-based systems, while developers can leverage storage capabilities and scalability, the developers are responsible for managing how application data is stored and accessed. This means developers must explicitly handle the layout of data, manage connections to databases or storage services, and perform serialization and deserialization processes when reading from or writing to storage. The persistent virtual memory system introduced in this decentralized computing platform abstracts state management. Developers no longer need to focus on how data is laid out in storage or manage state transitions explicitly. The platform handles memory allocation, state synchronization, and data retrieval automatically, which eliminates the need for repeated data transformation operations.

In certain embodiments, the persistent virtual memory system described herein may be implemented entirely in userspace, such that it may operate as a standard application process and interact with the operating system through existing interfaces such as file and memory management APIs. This approach avoids kernel-level modifications or the use of protocol-dedicated hardware. Instead, the system can utilize generic storage devices and standard operating-system functionality. The persistent virtual memory system may ensure deterministic persistence, that is, the ability to reproduce identical computational results across repeated executions, by managing the service-level state through memory-mapped regions (which link files directly to addressable memory), copy-on-write paging (which records only modified memory pages), and versioned backing storage (which maintains historical versions of data). Ordered state updates may be recorded directly within a non-volatile memory space associated with each service instance to capture reproduceable changes over time. By virtualizing state at the page level and maintaining a consistent in-memory representation across executions, the decentralized computing platform can provide deterministic execution semantics without depending on conventional database systems or hardware-assisted ledger mechanisms. In various non-limiting examples, this architecture allows the decentralized computing platform to execute efficiently on general-purpose computing devices, such as laptops, consumer desktops, embedded processors, Internet-of-Things (IoT) devices, and mobile hardware such as smartphones or tablets. This represents a technical improvement over traditional blockchain execution environments that rely on specialized validator machines, tightly integrated consensus-storage layers, or redundant execution across all participating nodes.

Such a decentralized computing platform also provides a flexible communication framework (e.g., may also be referred to as universal procedure call or UPC), which enables decentralized services to communicate without relying solely on blockchain consensus. This framework supports multicast calls to multiple nodes simultaneously, with configurable thresholds for fault tolerance, latency, and reliability. Such a flexible communication framework may facilitate off-chain communication by allowing services to interact directly with multiple nodes through multicast-enabled calls without the need for every message to go through a blockchain. This flexible communication framework may structure off-chain computation using multicast operations with customizable redundancy, where the degree of fault tolerance, latency, and reliability can be configured for each interaction based on the service's needs. For example, critical operations such as financial transactions may require consensus from multiple nodes, while less critical operations can proceed with fewer participants to reduce latency.

In one embodiment, the disclosed decentralized computing platform further incorporates a global causal coordination framework, referred to herein as a Fate-Constrained Ordering (FCO) system. The FCO system may enforce causal relationships among decentralized services while maximizing concurrency for operations that are independent. Rather than enforcing global replication through redundant execution across all nodes, FCO separates the sequencing (i.e., establishing the global order of operations) from the execution (i.e., performing the actual computations). A sequencer of the platform may generate a global event log (may also be referred to as a fate sequence), in which each service-level transaction is assigned a unique position representing its relative causal relationship to other transactions. Nodes hosting a given service execute only those transactions relevant to their hosted services while remaining consistent with the overall fate sequence. Through this approach, the FCO system preserves deterministic state evolution across all services without requiring every node to re-execute every operation.

The FCO mechanism may further include a dependency resolution layer configured to manage dependency information between interdependent services. Each service may define a dependency set identifying other services that it may invoke or that may influence its operational state. The system aggregates these dependency sets into a dependency graph representing causal prerequisites among services. When a node receives a new globally ordered event, the node determines which prior events from other services must complete before local execution can proceed. This ensures that any operation relying on the results of another service executes only after the relevant prior outcomes are finalized. With the dependency information, each node can independently compute its assigned portion of the sequence without maintaining awareness of unrelated events. The system thereby achieves deterministic, parallel execution and allows unrelated services to proceed concurrently while maintaining consistent global outcomes.

Approaches in accordance with at least one embodiment may at least provide several technical advantages over traditional blockchain and cloud-based architectures by addressing limitations such as computational redundancy, memory management inefficiencies, and communication bottlenecks.

For example, in conventional blockchain networks, such as Ethereum, all nodes must redundantly execute every transaction and store the entire state, which results in high latency, limited scalability, and inefficient use of resources. In contrast, approaches in accordance with the present disclosed decentralized platform introduce a service-oriented model that separates transaction sequencing from computation and allows nodes to selectively participate in specific services based on their resource capabilities. Methods and approaches disclosed herein eliminate the need for full replication across the network, as nodes only host and process services relevant to their available hardware and preferences. Each service operates independently using its own governance logic, with the sequencer component coordinating the ordering and notarization of function calls to ensure a consistent transaction history across participating nodes. Nodes are not required to subscribe to every transaction or service. Instead, they selectively join services aligned with their hardware capabilities, such as AI computation, content delivery, or DeFi operations, which creates a dynamic and decentralized hosting marketplace unseen in traditional decentralized platforms.

Additionally, disclosed approaches in accordance with various embodiments leverage a persistent virtual memory system to overcome the state management bottlenecks in existing blockchain virtual machines (VMs), such as the Ethereum Virtual Machine (EVM) and Move VM. For example, traditional VMs may rely on serialization and deserialization of state data to and from disk or database-based storage which introduces significant I/O overhead during every function call or transaction. Cloud-based systems, while scalable, do not abstract state management from developers. These cloud-based systems provide explicit access to storage, which requires developers to manage data layout, connections, and perform serialization and deserialization directly. In contrast, approaches in accordance with a disclosed persistent virtual memory system provide an efficient and persistent virtual memory architecture designed to overcome execution bottlenecks commonly encountered in blockchain platforms and cloud-based environments. Such a persistent virtual memory system maintains persistent virtual memory across different execution instances and eliminates the need for frequent writes and reads from external storage. A persistent virtual memory system handles both service-level and instance-level state. The service-level state is shared among all nodes running the same service and ensures that global variables are consistently synchronized across these nodes. Instance-level state is local to each node, allowing for private, node-specific operations that do not require synchronization across the network. Additionally, the persistent virtual memory system described herein provides an efficient and continuous memory structure that keeps data accessible across different operations and eliminates the need to constantly read from or write to external storage. Developers are not required to possess knowledge about how to organize or manage data. Such a persistent virtual memory system automatically handles how data is stored, accessed, and synchronized. This makes development more straightforward and efficient. By abstracting these technical operations, the system not only improves performance but also makes the development process more accessible to a wider range of users. As a result, these functionalities become more universally available and empower more people to build, innovate, and contribute to the decentralized platform.

Moreover, one key technical advantage of such a persistent virtual memory system lies in its userspace paging system, which allows a memory architecture to function like an operating system (OS) within the virtual machine. Such a design allows the virtualized memory to remain directly accessible and addressable in the node's volatile RAM, even if it is non-volatile conceptually. Userspace paging ensures that only the relevant pages of memory are kept in the node's volatile RAM, while other portions of the state remain available for quick access without requiring serialization. Such a feature enables the platform to dynamically swap and patch memory pages directly into the process memory of the host when needed such that both service-level and instance-level states remain readily available for execution without the need for costly state translations. As a result, systems and methods disclosed herein may reduce the latency and computational overhead typically associated with conventional blockchain platforms, where state data must be reloaded and processed at every transaction. Such a platform may further optimize memory management through a copy-on-write (CoW) mechanism where only modified memory segments are persisted during state updates. Such a feature eliminates the need to rewrite entire data structures and significantly reduces disk I/O operations.

Furthermore, methods and approaches in accordance with at least one disclosed embodiment further introduce a flexible communication framework (Universal Procedure Call, or UPC) that extends beyond traditional systems by offering multicast-enabled communication with configurable fault tolerance in a decentralized environment. Existing decentralized systems often rely on blockchain consensus for inter-node communication, which introduces significant latency and limits scalability. Such a disclosed UPC framework enables nodes to interact directly off-chain and bypass the blockchain when consensus is not required. Users (such as developers) can specify the fault tolerance settings for each UPC call, including the required quorum of node responses and latency thresholds. For example, financial operations may require responses from multiple nodes to ensure consistency, while less critical services may operate with fewer participants for improved performance. A UPC system also supports partial result aggregation (e.g., similar to a MapReduce pattern), where individual nodes contribute partial results that are aggregated to form a final output. This enables complex multi-node computations, such as multi-party computations (MPCs) or decentralized exchanges (DEX) order matching, to occur efficiently without relying on the blockchain for every interaction. Additionally, such an approach divides the workload across participating nodes, which enhances the overall efficiency of the system. The aggregation mechanism also distributes trust among nodes, such that computations are more secure and private by reducing the reliance on any individual node for complete control of the process.

The FCO system provides additional technical improvements by introducing a dependency-aware coordination algorithm that enables parallel and selective execution of decentralized services. In traditional blockchain systems, global consistency is achieved through replication that requires every node to process every transaction, which limits specialization or task divisions. Sharded or side-chain architectures attempt to scale by having separate replication groups but lose atomicity in-between the groups, deterministic global ordering and often require complex reconciliation protocols. In contrast, the disclosed FCO system introduces a dependency-aware coordination algorithm that achieves both global determinism and distributed concurrency. Each decentralized service maintains dependency metadata identifying which other services may influence or be influenced by its state. This dependency information can be derived from static call graphs at deployment or dynamically refined at runtime based on observed cross-service calls. By leveraging this dependency graph, the FCO may determine which transactions must execute sequentially and which can safely proceed in parallel. The coordination based on dependency graph enforces a total global order while preserving causal dependencies such that every node progresses deterministically and deadlock-free without requiring global re-execution. This structure yields improvements in network throughput, transaction latency, and computational efficiency. Furthermore, by separating ordering from execution, FCO minimizes redundant computation and data transmission and allow nodes operating under different execution environment or hardware capabilities (e.g., including specialized environment such as GPU-heavy, IoT-light, or storage-focused) to participate selectively while still maintaining deterministic consistency and a globally enforced total ordering across all services.

Variations of this and other such functionality can be used as well within the scope of the various embodiments as would be apparent to one of ordinary skill in the art in light of the teachings and suggestions contained herein.

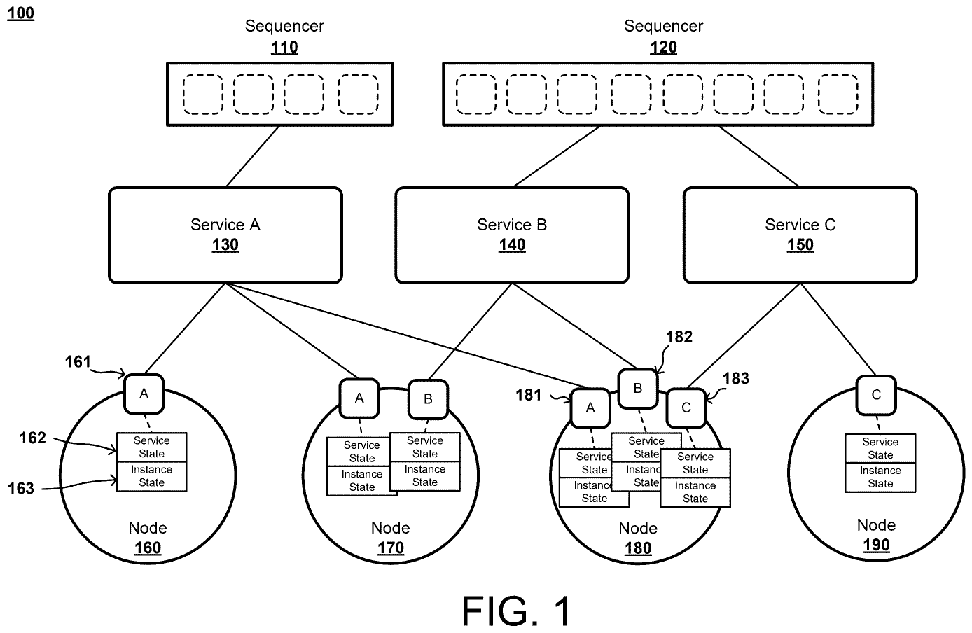

FIG. 1 illustrates an example decentralized environment 100 where multiple sequencers, services, and nodes collaborate to execute both on-chain and off-chain operations, in accordance with one example embodiment. As illustrated in FIG. 1, such a decentralized environment 100 may include multiple sequencers, such as sequencer 110 and sequencer 120. Each sequencer is responsible for managing the ordering and notarization of transactions for one or more services. For example, sequencer 110 manages the transactions and ordering for service A, while sequencer 120 manages the ordering for service B and service C. A sequencer, as used herein, may be a component that ensures all function calls and transactions within the services it manages are executed in the correct sequence to maintain consistency across the participating nodes. Sequencers may be implemented using various methods, such as a consensus network (where multiple participants agree on the order of transactions), a Zero-Knowledge Rollup layer (which bundles many transactions together with cryptographic proofs), or a centralized entity (a single organization managing the process). In one embodiment, the operations of a sequencer may be backed by a blockchain to provide an immutable ledger of all ordered transactions and enable state recovery in case of disruptions.

A service, as disclosed herein, may represent a decentralized application or workload that performs specific functions. Each service may operate independently, with its own governance rules, incentives, and operational logic. Examples of services may include decentralized finance (DeFi) applications, AI-powered computations, content delivery networks, etc. In one embodiment, services can operate without being tied to a single chain, and each service may select its own sequencer based on performance, fault tolerance, historical behaviors, or operational requirements. For illustration purposes, service A 130, service B 140, and service C 150 are depicted in FIG. 1, but the architecture is not limited to these services. Such a platform can support any number of services running simultaneously, depending on the needs of the network.

Such a decentralized system may also include multiple nodes, such as node 160, node 170, node 180, and node 190, which represent the computational hosts that run instances of the services. A node, as disclosed herein, may refer to a participating entity within a decentralized system, which may have specific hardware capabilities, preferences, and configurations. Each node can subscribe to one or more services based on these factors, such as available storage, computational power, or the service incentives (e.g. reward) it wishes to pursue. Nodes may upload transactions to the corresponding sequencer, which then broadcasts these transactions to all participating nodes. For example, if a node is involved in service A 130, it will send its transactions to sequencer 110. Sequencer 110 may collect and order the transactions, then broadcast the ordered set to all nodes hosting service A 130. This broadcast ensures that all nodes participating in the service maintain a synchronized state and consistent execution.

In some embodiments, the service itself, through its programmed logic (e.g., smart contract rules, verification modules, or service-level algorithms), may evaluate participating nodes using operational metrics such as historical reliability, responsiveness, observed latency, accuracy of submitted results, or other trust-related indicators. Based on such metrics, the service logic may assign roles, prioritize contributions, distribute rewards, or apply penalties or slashing to nodes that fail to meet required performance or correctness thresholds. In this manner, the service's rule set (e.g., defined by the service designer) governs participant evaluation and role assignment, distinguishing it from the nodes' independent decision to subscribe to or host an instance of the service.

For illustration purposes, the blocks labeled A, B, and C within each node in the diagram indicate the services that the node supports. For example, node 160 subscribes to service A (illustrated by block 161), which means node 160 participates in the operations of service A by executing function calls and maintaining service-related state. In one embodiment, a single node can engage with multiple services managed by different sequencers. For example, node 180 subscribes to multiple services, such as services A, B, and C (illustrated by blocks 181, 182, and 183) which are managed by multiple sequencers 110 and 120.

Unlike traditional blockchain platforms, where every node must process and validate all transactions across the entire chain, such a decentralized platform decouples sequencing from computation. As a result, a node only needs to interact with the services it subscribes to rather than replicating all operations in the network. A node does not need to participate in all services managed by a particular sequencer. For example, even though sequencer 120 manages both service B 140 and service C 150, a node such as node 190 may choose to subscribe only to service C, without having to participate in transactions associated with service B 140 which is also managed by sequencer 120. In one embodiment, nodes have the flexibility to unsubscribe from services at any time. Such flexibility allows nodes to dynamically reallocate resources or shift focus based on changing preferences or workload demands. For example, a node initially participating in service A may decide to unsubscribe and focus on service B if the latter offers more favorable incentives or aligns better with the node's computational resources. Additionally, services themselves have the ability to change their association with sequencers as needed. When a service changes its associated sequencer, any nodes that wish to continue supporting that service would need to align with the new sequencer to maintain their participation and support of the service.

Each node may maintain two types of state data, service state 162 and instance state 163 (or may be referred to as service-level state and instance-level state). The service state may refer to a shared, global state that is replicated across all nodes participating in a specific service. Service state data may include data such as account balances, service parameters, updates to service parameters that affect the behavior of some or all nodes hosting the service, transaction histories, etc. An instance state is local to each node and contains data specific to that node's operations, such as cache, intermediate computation results, session-specific data, node-specific operational parameters, or node-specific settings. This instance state allows nodes to perform independent operations without requiring continuous synchronization with other nodes.

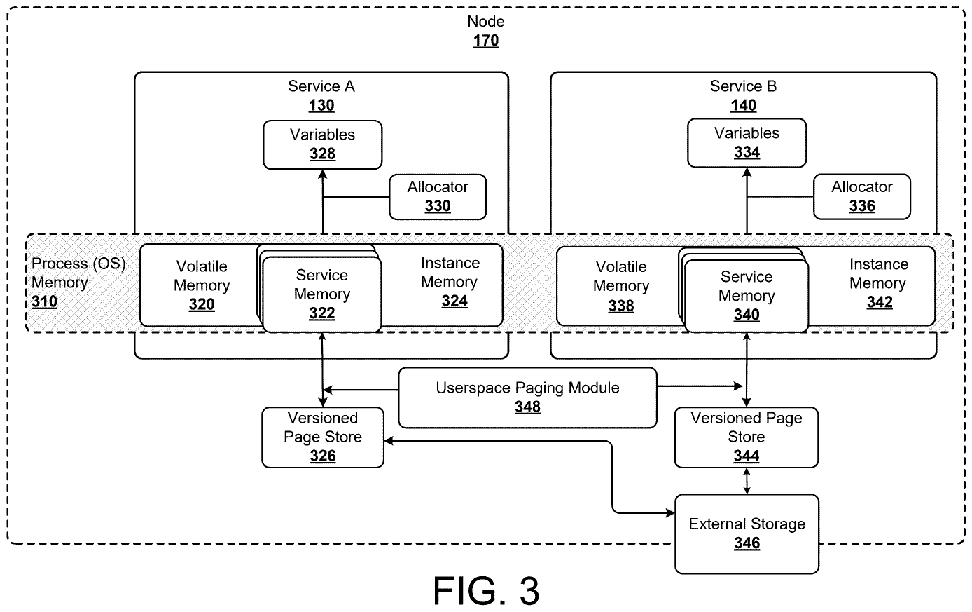

Both service state and instance state are stored within a persistent virtual memory system (e.g., LyteMemory), which ensures that state data remains available across transactions without the need for repeated serialization or deserialization. Such a persistent virtual memory system provides efficient state management by keeping both service-level and instance-level data accessible directly in the virtual memory associated with each service. A persistent virtual memory system is discussed in further detail in accordance with FIG. 3.

In certain embodiments, the decentralized computing platform may implement a unified programming model that allows both on-chain and off-chain logic to coexist seamlessly within a single source-level framework. Traditional blockchain development typically requires developers to separate on-chain contract logic from off-chain application logic, often using distinct software stack or runtime environments. By contrast, the disclosed platform enables developers to declare and manage both network-wide (on-chain) and node-local (off-chain) state within a single deterministic programming construct. The following code example, reproduced from an illustrative embodiment, demonstrates this unified declaration:

```
        lyquid::state! {
          // On-chain state
          network total_supply: U256 = U256::ZERO;
          network balances: network::HashMap<Address, U256> = network::new_hashmap( );
          // Off-chain state (unique to Lyquid)
          instance local_transactions: Vec<Transaction> = Vec::new( );
        }
```

As shown, variables identified by the network modifier represent shared network-level state synchronized among participating nodes hosting the same service, whereas variables identified by the instance modifier correspond to local node-level state maintained privately by each node. Both types of variables are defined together under a single syntax and are executed within a common runtime environment. This allows developers to express decentralized service logic without dividing their codebase between separate on-chain and off-chain subsystems, thereby improving consistency, portability, and verifiability of the resulting applications. In certain implementations, compiler tools may automatically generate compatibility layers that expose such unified constructs through standard blockchain APIs while preserving deterministic semantics. The code shown above is presented for explanatory purposes only and is not limiting; other syntactic forms, languages, or abstractions may be employed to achieve a similar unified on-chain/off-chain programming model.

To coordinate the interactions between multiple services and nodes illustrated in FIG. 1, the decentralized platform may implement a global ordering and coordination mechanism, referred to herein as a fate-constrained ordering system (i.e., FCO). FCO may include a deterministic sequencing mechanism that establishes a global causal order of service operations across the decentralized environment. The FCO mechanism may ensure that transactions and function calls executed across the decentralized platform maintain deterministic order and composability while allowing selective execution by nodes hosting different decentralized services. Unlike traditional blockchain systems, where each node redundantly executes all transactions within a global ledger, FCO may enable global consistency of transaction ordering without requiring universal execution of every operation by every node.

In some embodiments, FCO may define a global causal order across service operations based on sequencing information obtained from one or more sequencing components (or may be referred to a sequence backend), which may include, but are not limited to, consensus-driven sequencers, a distributed ledger, transaction-ordering service, or any sequence providing subsystem. The sequencing component may maintain a transaction log or equivalent ordered data structure that establishes the definitive sequence of events across the network. FCO system may derive or reconstruct a consolidated and deterministic sequence, referred to herein as a fate sequence, by querying, subscribing to, or otherwise receiving ordering data from such sequencing components. Each service transaction or function invocation can be associated with a unique ordering identifier that specifies its relative position with respect to other operations in the network. This global ordering information encodes relationships among potentially interdependent services and may be referred to such that each operation is executed consistently with its upstream and downstream dependencies. During execution, participating nodes may retrieve operations corresponding to the services they host and execute those operations in accordance with their assigned positions within the fate sequence. In one embodiment, a sequencing component may be a sequencing subsystem within each participating node. In one embodiment, a sequencer may function as an abstraction layer that locally reconstructs the same ordered log of transactions based on sequencing information obtained from one or more underlying sequence backends, such as a ledger, consensus component, or other transaction-ordering mechanism. By decoupling sequencing from execution, the FCO framework enables nodes to process only the subset of operations relevant to their hosted services while maintaining deterministic consistency with the globally ordered transaction record provided by the sequencing infrastructure.

In at least one embodiment, the FCO system may further define and manage dependency relationships that represent causal linkages among service-level operations within the fate sequence. Each dependency may specify that the execution of a particular service operation is conditioned on the completion or finalization of one or more preceding operations in the globally ordered sequence. Dependencies may be expressed as structured metadata associated with each operation, describing, for example, the set of service identifiers, state objects, or communication channels that the operation intends to access or modify. In some embodiments, developers may provide explicit dependency declarations or annotations within service definitions or deployment configurations to guide dependency resolution and control the scope of ordering constraints. Such declarations may indicate, for example, that an operation must await a specific upstream event, or that it can proceed speculatively when no shared state conflicts exist. In some implementations, the sequencing component or an associated coordination layer may infer such dependencies automatically by analyzing the transaction data, declared state references, or inter-service communications observed within submitted operations. If two operations reference overlapping state regions or shared service identifiers, the system may infer a causal dependency and enforce an appropriate execution order within the fate sequence. Conversely, operations that reference disjoint state or unrelated services may be treated as independent and scheduled concurrently.

The dependency information may be distributed together with the fate sequence for nodes to determine which portions of the globally ordered record are relevant to their hosted services. Each node can thus selectively retrieve and execute only those operations that involve its associated services or declared dependencies, while remaining consistent with the global order of execution. By defining and enforcing these dependency relationships, the FCO framework facilitates parallel execution of independent operations across different nodes and sequential execution of dependent operations according to their causal order in the fate sequence.

In some embodiments, the decentralized platform may comprise at least two categories of computational participants that operate cooperatively under the FCO coordination model: archival nodes and lightweight nodes (also referred to as regular nodes). Archival nodes may maintain a complete and authoritative record of the fate sequence established by the FCO framework, together with the resulting global service-level state across all services. Each archival node may store every ordered operation emitted by one or more sequencing components within the network, along with the corresponding state transitions or versioned outputs generated by those operations. This persistent data set enables archival nodes to function as long-term custodians of the network's execution history and as reference authorities for reconstructing or validating state across services. In certain implementations, archival nodes may participate in all services either actively or passively, subscribing to multiple sequencers and capturing inter-service events, including implicit cross-service invocations, that occur within the globally ordered execution environment. By continuously maintaining a complete causal history of ordered operations, archival nodes ensure that at least one group of participants preserves a canonical, verifiable, and temporally consistent record of all network activity.

In some embodiments, the FCO mechanism applies only to the on-chain component of service execution. The FCO layer records an ordered stream of service-level events, transactions, or other state-transition metadata that contribute to the evolution of the globally shared state. These fate-ordered records capture the portion of service behavior that must be reproduced deterministically across the network, such as version changes, state-update commitments, settlement actions, or other effects that influence shared resources. Off-chain computation, such as local processing, inference, simulation, or any service-specific workload executed within a node's private runtime, is not sequenced by FCO and does not contribute directly to the shared on-chain state. Instead, the outputs or commitments associated with such off-chain computation may later be referenced by an on-chain action, which then appears in the FCO sequence. Archival nodes therefore maintain the globally shared execution history: the on-chain fate-ordered sequence and the associated dependency metadata required to reconstruct and verify shared state transitions, without storing or replaying full off-chain computations.

In contrast, regular nodes (or lightweight nodes) may host only a subset of services selected according to their computational capabilities, designated roles, or incentives within the decentralized environment. Each regular node may subscribe to one or more sequencing components corresponding to its hosted services and, when applicable, to any directly related services identified through the dependency relationships defined by the FCO system. Regular nodes generally do not replicate the complete fate sequence. Instead, they may rely on archival nodes or other verification providers to obtain authenticated information, such as cryptographic proofs, state digests, or service-level checkpoints, pertaining to operations or services that they do not maintain locally. In some embodiments, regular nodes act as validators for the specific services they host by independently reconstructing and verifying the relevant portions of state from execution. This differs from some node implementations in other blockchain architectures, which do not perform validation and instead follow finalized results produced by full nodes. In the disclosed system, validation responsibility is distributed across nodes according to service-level interest and capability rather than rigid node classes, thereby enabling heterogeneous execution environments while maintaining global ordering and deterministic consistency.

In one example embodiment, retrieval of complete service-level state from an archival node occurs infrequently, such as only during initial bootstrap or recovery. Rather than performing frequent full-state synchronization, the regular node may synchronize by requesting only the ordered log of relevant events from archival nodes and then locally re-executing those events to reconstruct its state. Because the event log is deterministic and globally ordered by the sequencing component, the regular node can reproduce the correct service-specific state transitions without relying on external state snapshots. This log-based synchronization approach provides several technical advantages. For example, it reduces the trust required in archival nodes, as the retrieving node does not depend on externally supplied state values; instead, it independently recomputes its local state from authenticated ordered events, improving correctness and security. Further, it lowers bandwidth and computational overhead, since replaying incremental events is far more efficient than repeatedly transferring complete state snapshots, which may be large and expensive to serialize.

During execution, a regular node may retrieve from the sequencing layer the ordered subset of operations relevant to its hosted services, along with associated dependency metadata. For each operation, the node can determine, based on the fate sequence and declared dependencies, whether prerequisite operations involving external services have been finalized. If such dependencies reference non-hosted services, the node may query an archival node to obtain the latest verified state or event record corresponding to those services. This ensures that execution proceeds in accordance with the global causal order without requiring full state replication. When operations are determined to be independent, that is, when their dependency sets do not overlap, the regular node may execute those operations concurrently, subject to the ordering guarantees of the fate sequence. This selective and dependency-aware execution model enables regular nodes to preserve deterministic correctness and composability while achieving higher throughput and computational efficiency through parallel processing of non-conflicting operations.

In some embodiments, the interaction between regular nodes and archival nodes may be governed by a verification and synchronization protocol that facilitates dependency resolution and state validation under the FCO coordination model. When executing operations derived from the fate sequence, a regular node may issue authenticated queries to one or more archival nodes to obtain verifiable data corresponding to external dependencies. Such data may include, but is not limited to, cryptographic proofs of inclusion within the global ordering log, state digests representing finalized service states, or event attestations confirming completion of dependent service calls. Archival nodes, in response, may provide the requested verification artifacts together with associated metadata, such as ordering identifiers, version numbers, and timestamps, to enable the requesting node to confirm that the referenced dependency has been finalized in accordance with the global causal order. Upon receipt of validated dependency data, the regular node may continue execution of its local operations without recomputing or re-executing the external service logic. In some implementations, this exchange may occur through a lightweight synchronization layer or message bus that supports subscription-based or on-demand retrieval of dependency data. The protocol may include mechanisms for caching verified digests, updating local dependency states incrementally, and invalidating outdated references when subsequent updates are observed in the fate sequence. Through this cooperative verification process, regular nodes maintain deterministic consistency with the global execution record while minimizing redundant computation and network overhead, thereby enhancing overall scalability and efficiency of the decentralized platform.

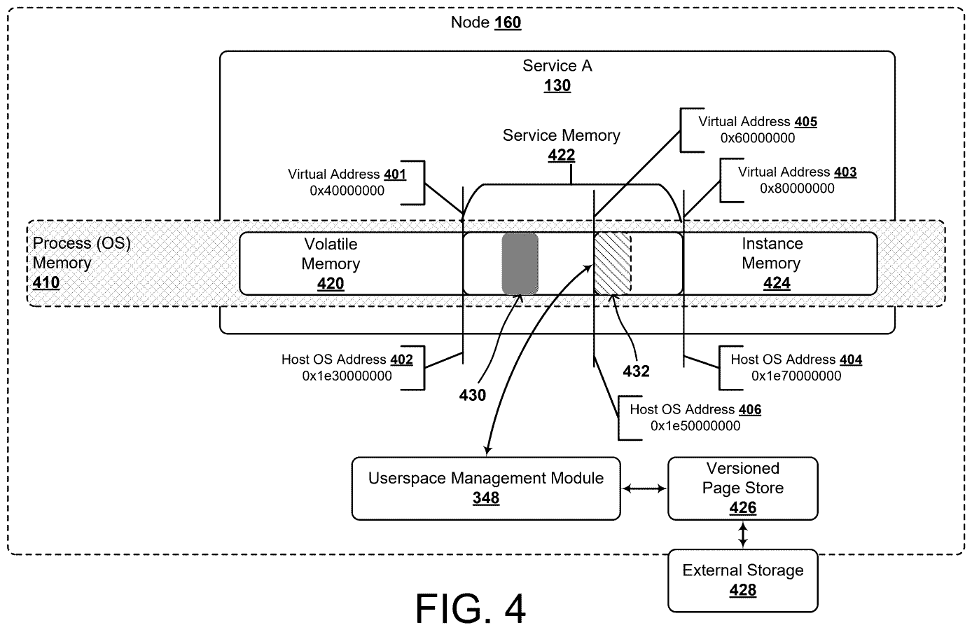

In one embodiment, the FCO may be operatively integrated with the platform's persistent virtual memory subsystem (described in further detail with reference to FIGS. 3-4) to maintain deterministic and verifiable state evolution across services. Each entry in the fate sequence may correspond to a discrete operation within a service and include a reference pointer or identifier to a version of the service-level state stored within persistent virtual memory. When a node executes a service operation, the node may retrieve the relevant state version from non-volatile storage, apply the ordered modifications prescribed by the fate sequence, and commit the resulting state as a new version. Each newly committed version may be cryptographically linked to its predecessor to produce a verifiable chain of state transitions that directly reflects the global causal order established by the FCO framework. This cryptographic linkage ensures that any alteration or omission within the state history is detectable, thereby providing integrity and non-repudiation of the execution record. By coupling deterministic ordering with version-controlled memory, the platform enables a participating node, including both archival and regular nodes, to reproduce, audit, or verify historical state transitions directly from stored state versions without re-executing prior computations. The alignment between the fate sequence and the persistent memory versioning guarantees that the participants maintain a consistent, reproducible, and tamper-evident record of computation across the decentralized environment.

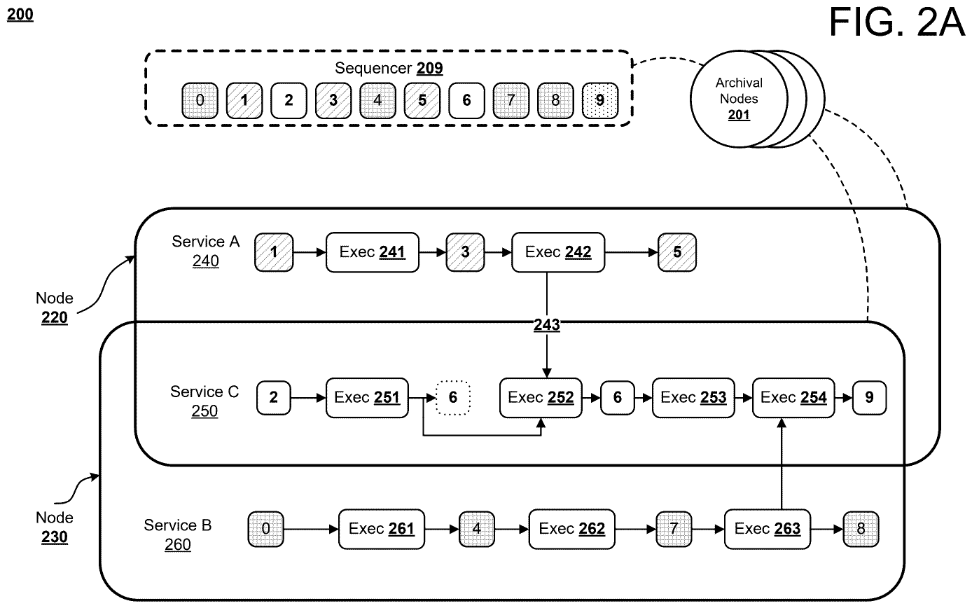

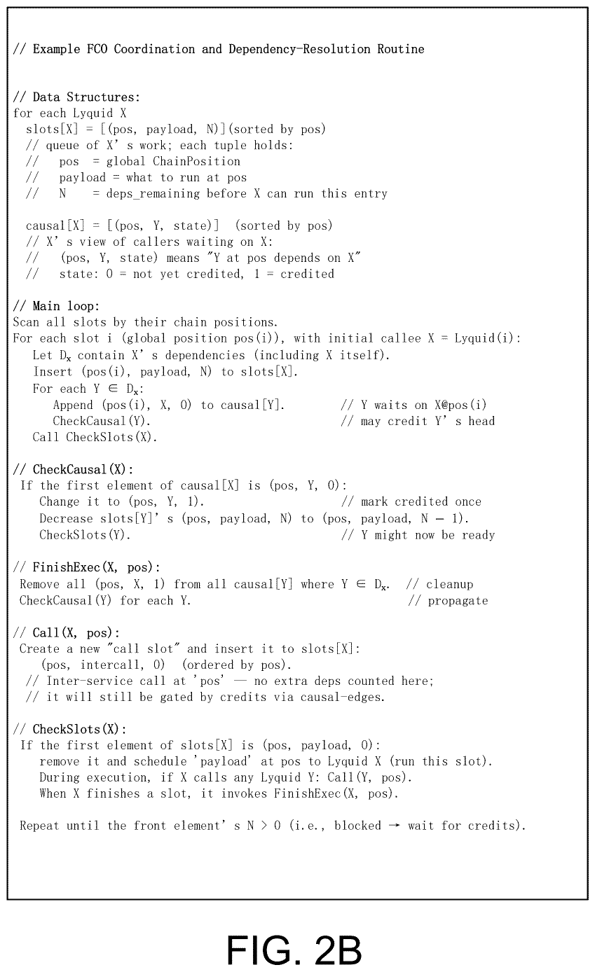

FIG. 2A illustrates an example embodiment 200 of a fate-constrained ordering (FCO) system, in accordance with some embodiments. As shown, a sequencer 209 may represent a sequencing subsystem within each participating node that is responsible for deriving the global order of service-level operations. In one embodiment, a sequencer may function as an abstraction layer that locally reconstructs the same ordered log of transactions based on sequencing information obtained from one or more underlying sequence backends, such as a ledger, consensus component, or other transaction-ordering mechanism. Each entry within this log may correspond to a deterministic position in a fate sequence that defines the canonical execution order of all service operations within the decentralized platform. The sequencer 209 may obtain ordering information from one or more underlying ledgers, consensus components, or transaction-ordering backends, and may assign a unique ordering identifier or index to each invocation. This index encodes the service operation's relative position and causal relationship with respect to other operations recorded in the global sequence.

One or more archival nodes 201 may subscribe to the sequencer's output stream to replicate the global fate sequence in its entirety. In doing so, the archival nodes 201 may maintain an execution history of the on-chain or service-level state portion of service operations, including associated dependency metadata and versioned service-state information stored within the platform's persistent virtual memory subsystem. In some embodiments, portions of this dependency information may be initialized during service deployment, when each service registers its callable interfaces, external references, and potential inter-service linkages with the FCO coordination layer. This registration establishes a baseline dependency map reflecting the service's declared communication boundaries. During runtime, as operations are emitted through the sequencer, archival nodes continuously augment this record by capturing actual invocation relationships and state interactions that influence the shared service-level state. In one embodiment, because FCO governs the ordered, globally shared portion of computation, and not private, off-chain, or instance-level execution, archival nodes preserve the authoritative history required to reproduce the evolution of the shared state. The resulting dataset provides an authoritative and tamper-evident ledger of global execution activity, including both the static dependency graph known at deployment and the dynamic causal relationships observed during execution. By maintaining this comprehensive history, archival nodes enable reconstruction, verification, and causal analysis of any service-level transaction across the decentralized environment.

Regular or lightweight nodes, such as node 220 and node 230, may host a subset of services and therefore execute the operations relevant to those hosted services. In the illustrated embodiment, node 220 hosts service A 240 and service C 250, whereas node 230 hosts service B 260 and service C 250. Each node receives the ordered sequence of operations from the sequencer and evaluates, for each incoming transaction, whether the operation pertains to a service it hosts. If the operation corresponds to an unrelated or independent service, the node may skip execution. However, if the operation involves a service dependency, either because the local service references shared state or performs a call into another service, the node queries one or more archival nodes to obtain the latest verified state version or dependency proof required for consistent execution. This mechanism enables nodes to execute only relevant subsets of the global sequence while preserving deterministic alignment with the globally ordered fate sequence maintained by the sequencer and archival infrastructure.

As depicted in FIG. 2A, the sequencer 209 may maintain a global fate sequence as an ordered series of identifiers 0 through 9, each corresponding to a service-level transaction. Each numbered box may represent a transaction as defined by the global fate sequence, and the rectangular “Exec” boxes that follow each numbered box represent the execution steps that process those transactions on the corresponding service. In the illustrated embodiment, transactions associated with service A 240 are represented by boxes filled with diagonal hatching, transactions associated with service B 260 are represented by cross-hatched boxes, and transactions associated with service C 250 are represented by white boxes. The ordered sequence defines the relative position of every transaction across the decentralized platform. In this example, service A 240 may execute transactions 1, 3, and 5; service B 260 may execute transactions 0, 4, 7, and 8; and service C 250 may execute transactions 2, 6, and 9.

When node 220 begins execution 241 of transaction 1 for service A 240, no dependency with other services exists, so the corresponding execution 241 step proceeds immediately. Transaction 3 for service A 240, however, introduces a dependency. During its local execution 242, service A invokes 243 a call of service C 250 to update a shared resource, such as a liquidity-token pool used by multiple decentralized exchanges. Because service C maintains the canonical state of that shared asset, the invocation from service A establishes a causal dependency between transaction 3 and a subsequent transaction 6 that also modifies service C. The FCO coordination layer records this relationship in the global fate sequence, indicating that operation 6 must not finalize until operation 3 has completed. Before node 220 executes the local execution step 252 corresponding to transaction 6 of service C, it may temporarily halt and query one or more archival nodes 201 to confirm that all upstream operations affecting the same state, such as the completion of execution 242 within service A, have been committed in accordance with the global sequence. Once the archival node verifies that the dependency chain is satisfied, node 220 resumes execution 252 on service C 250. This verification-before-execution procedure prevents race conditions and ensures that service C's view of the shared resource is globally consistent.

To illustrate, suppose service A executes a trade that deducts 100 USDC from the shared pool managed by service C, while service B later executes a separate trade that deducts 50 USDC from that same pool. If both operations were processed concurrently without dependency control, the combined deductions might incorrectly exceed the available balance or produce divergent results on different nodes. Under the FCO mechanism, transaction 3 (service A's deduction) receives an earlier position in the fate sequence than transaction 6 (service C's update) and transaction 7 (service B's deduction). Before node 220 performs the local execution 252 corresponding to transaction 6 of service C, it temporarily halts and queries one or more archival nodes 201 to verify that all upstream operations affecting the USDC balance, such as the completion and finalization of execution 242 within service A, have been fully committed in accordance with the global sequence. Once the archival node confirms that the dependency chain is satisfied and that the 100-USDC deduction from service A is finalized, node 220 proceeds with execution 252 on service C 250 to reflect the updated balance. This verification-before-execution procedure prevents race conditions and ensures that service C's view of the shared resource remains consistent across all nodes hosting related services.

A similar dependency arises for transaction 7 associated with service B 260. Service B represents another decentralized exchange drawing from the same shared liquidity pool maintained by service C 250. Within the fate sequence, transaction 7 follows transaction 6, and its local execution 263 likewise references service C. The FCO framework, using dependency metadata embedded in the sequencer's global log and mirrored by archival nodes 201, determines that service C's next operation (execution 253) must wait until transaction 7 has completed and been finalized. In FIG. 2A, this deferred execution is depicted by adjacent execution boxes (e.g., 251 scheduled to 252 and 253 scheduled to 254), where the first box denotes a pending or scheduled step awaiting confirmation, and the subsequent box represents the actual execution that occurs once confirmation is received from the archival layer.

As such, each node applies only the portion of the global fate sequence corresponding to the services it hosts, while remaining synchronized with the overall ordering established by sequencer 209 and verified through archival nodes 201. Nodes that do not host a particular service may omit unrelated entries without deviating from the globally consistent timeline. When a dependency is detected, the node may suspend execution of the affected operation until confirmation is received that all prerequisite operations in the dependency chain have finalized; when no such dependency exists, the operation may be executed immediately and potentially in parallel with other independent operations. Through this dependency-aware scheduling, the FCO framework provides selective execution for efficiency and composable coordination for determinism, thereby preserving atomicity, global consistency, and horizontal scalability across all participating services. By enforcing these dependency constraints, the FCO mechanism allows each node to execute only the subset of operations relevant to its hosted services while maintaining deterministic, globally consistent state transitions. Operations that share no dependencies, such as transactions 0 and 1 associated with independent services, may execute concurrently on separate nodes, whereas dependent operations are automatically serialized according to their causal order in the global fate sequence.

FIG. 2B illustrates an example coordination and scheduling routine implementing the FCO mechanism, in accordance with some embodiments. The routine represents an example internal control logic through which the FCO framework enforces deterministic and dependency-aware execution of service-level operations across a decentralized network. The algorithm functions as a distributed scheduler that receives ordered operations from the sequencer and determines, for each service (Lyquid), when a given operation may execute based on its dependency state. Such an algorithm may ensure that all services advance through the globally ordered fate sequence in the same causal order while allowing independent operations to be processed concurrently to maximize throughput.

Each service maintains at least two data structures that together implement this coordination logic. A slot list (slots [X]) maintains upcoming operations for a given service X, where each entry includes a global ordering position (pos), a payload reference (payload), and a counter (N) indicating the number of unresolved dependencies that must complete before execution. A causal list (causal [X]) maintains pending causal relationships between services, where each record (pos, Y, state) denotes that service Y depends on service X at the specified global position and whether that dependency has been acknowledged. These structures collectively represent the dynamic dependency graph that a scheduler uses to control execution flow.

During operation, the scheduler continuously ingests new entries from the global fate sequence and processes them according to stages: dependency registration, readiness evaluation, and execution with completion propagation. When a new ordered operation is received, the routine identifies the set Dₓ of dependencies associated with the target service X, including X itself. The scheduler then creates a slot for this operation by inserting (pos, payload, |Dₓ|) into slots X, where the initial dependency count equals the number of services on which X depends. For each dependent service Y in Dₓ, the scheduler appends a record (pos, X, 0) to causal [Y] indicating that the operation X at pos must not execute until Y has completed all of its own operations that precede this position in the global sequence. In one embodiment, although service Y has already executed all such earlier operations, the newly appended causal entry may still need to wait behind preceding entries in causal Y if those represent unresolved dependency obligations for Yp. The scheduler then invokes the CheckCausal(Y) procedure, which determines whether these prior obligations have been satisfied and whether Y can credit this dependency for X at pos. After all causal entries have been registered, if the dependency count for X at pos reaches zero, the operation is immediately scheduled for execution through the CheckSlots(X) procedure.

The supporting procedures collectively maintain synchronization and propagate completion events throughout the dependency graph.

The CheckCausal routine acts as a dependency notifier, examining a respective service's causal list to determine when dependent operations in other services may be advanced. For a given service X, entries in causal X of the form (pos, Y, state) indicate that the operation Y@pos depends on X. When the head entry in causal X has state 0, this condition reflects that X has progressed far enough in the global fate sequence that all of its operations that should precede Y@pos have been executed. The routine then marks the dependency as acknowledged (sets the state to 1), decrements the outstanding dependency counter for Y@pos in slots Y, and invokes CheckSlots(Y) to determine whether that operation has now satisfied all of its dependencies and is eligible for execution.

The CheckSlots routine functions as a local scheduler for each service. It examines the head of slots [X] and repeatedly dispatches any operation whose counter has reached zero, thereby triggering its execution. This process ensures that all operations that satisfy their dependencies execute without delay. This enables parallel execution of operations that do not share dependencies, while dependent operations automatically remain suspended until their prerequisite counters reach zero.

The FinishExec routine operates as a finalizer that executes once a service X completes an operation at a given global position. It removes corresponding acknowledged causal entries (pos, X, 1) from the causal lists of other services in Dₓ and calls CheckCausal(Y) for each dependent Y to propagate the completion signal and trigger any newly unblocked operations.

The Call routine handles inter-service invocations generated during runtime, creating a temporary “call slot” (pos, intercall, 0) in the target service's slot list to preserve correct ordering for cross-service function calls. These dynamic links allow one service to invoke another while remaining consistent with the global fate sequence.

As a result of these interactions, the scheduler behaves as an event-driven coordination engine in which every service both publishes and consumes dependency confirmations. When an operation has no outstanding dependencies, it executes immediately and may run in parallel with unrelated tasks hosted by other nodes. When a dependency exists, such as when multiple services attempt to update a shared token balance, the dependent service pauses automatically until confirmation of the prerequisite operation is received, typically through verification data supplied by an archival node or other confirmation source. Once the upstream completion is verified, the dependent counter reaches zero, and execution proceeds deterministically in the order prescribed by the global fate sequence.

Accordingly, the coordination algorithm depicted in FIG. 2B provides, at least as an example, the underlying execution semantics of the FCO system. It ensures that interdependent services operate in global order, that independent services exploit available parallelism, and that all participants maintain an identical, verifiable progression of state transitions across the decentralized platform. Through this mechanism, the system achieves deterministic composability, efficient resource utilization, and globally consistent execution without requiring universal replication of every operation by every node.

FIG. 3 illustrates an example embodiment of memory management within a node 170, in accordance with one disclosed embodiment. In the embodiment shown in FIG. 3, node 170, as illustrated in FIG. 1, may run instances of service A 130 and service B 140. Each service operates independently and maintains its own variables 328 and 334 and allocators 330 and 336. As illustrated, each service may operate with its own set of variables and uses an allocator to manage the assignment and reuse of the process memory or OS memory 310. The process memory 310 may refer to the segment of a computer's physical memory, commonly known as RAM (Random Access Memory), assigned to a running application or service by the operating system. Variables, as used herein, may contain essential operational data, such as balances, counters, or other parameters needed for the service's execution. Allocators may ensure that memory is allocated efficiently and may distribute resources based on demand. The allocators 330 and 336 are used to manage both shared service memory, such as 322 and 340, and instance-level memory, such as 324 and 342.

As illustrated in FIG. 3, a persistent virtual memory system may involve an architecture that is designed to distinguish between volatile memory (e.g., 320, 338), service memory (e.g., 322, 340), and instance memory (e.g., 324, 342). In one embodiment, approaches in accordance with a disclosed decentralized system leverage a high-performance runtime environment to execute decentralized services on the node. This environment ensures that each service operates efficiently, securely, and independently, without interfering with other services or the underlying operating system. For example, the runtime environment isolates each service such that service A 130 and service B 140 can run simultaneously on the same node 170 without conflicts, even if they use different programming models or access different parts of the process memory 310. In one embodiment, WebAssembly (WASM) is used for this runtime environment. Such a disclosed system may ensure that services can execute on any node, whether the node runs on a high-powered cloud server or a small personal computer by using WASM, which may translate code into a form that can run on any type of computer, regardless of the operating system or hardware configuration.

In the example embodiment illustrated in FIG. 3, each service may operate within its own WASM instance, which acts like a sandbox that keeps the service's operations separate from others. Although WASM is discussed, such a decentralized system is designed to support alternative runtime environments beyond WASM. For example, services can be deployed in Docker containers or lightweight virtual machines when additional operating system resources are required, such as in machine learning or data-intensive analytics. In other cases, financial applications may benefit from using the Move Virtual Machine (Move VM), which offers a secure environment for deterministic financial transactions and smart contracts.

Within each node, each service, such as service A and service B, can be allocated its own set of volatile memory, service memory, and instance memory. Volatile memory 320 and 338 may refer to temporary memory and exist only for the duration of a specific function call or operation. After the function completes, volatile memory is cleared, which makes it suitable for storing intermediate values or temporary calculations. Service memory 322 and 340 is a persistent, shared memory that maintains the global state of the service and ensures consistency across all participating nodes. Service memory allows nodes to synchronize their operations, so all participants in the service work with the same data, such as configurations, liquidity pools, or shared balances. Instance memory may provide node-specific storage and store data that is relevant only to the operations of a particular node. This instance memory enables nodes to perform computations independently, without requiring synchronization with other nodes. For example, intermediate computation results, session-specific data, or cache may reside in instance memory. Instance memory allows for private execution without impacting the shared service state.

Each section of memory may include multiple pages, where a page may represent the smallest unit of memory allocation. Memory may be divided into logical pages to enable granular tracking and management of changes. Each service and instance memory segment is divided into pages, and any updates to the state may occur at the page level. The size of a page in the node's operating system (OS) may differ from the logical page (e.g., may also be referred to as a virtual page) size defined by a disclosed persistent virtual memory system. In one embodiment, the logical page size may be smaller to capture finer-granularity changes at the service level. For example, a host OS may use a larger page size, such as 4 KB, while logical pages in the persistent virtual memory system may be smaller to track more precise state changes.

In one embodiment, a disclosed architecture may include allocators (such as 330 and 336) designed to be non-volatile. That is, the memory allocation state is persisted and can be restored across subsequent calls or node restarts. In traditional systems, memory allocators are volatile, that is their state exists only during the runtime of a process, and when the process terminates or the node restarts, all memory allocation information, such as pointers, memory addresses, and metadata, is lost. In contrast, in a disclosed embodiment, metadata associated with the allocator and the variable references for allocated objects are stored in non-volatile storage such that memory allocations are preserved across service executions and node restarts. The persisted metadata includes information about memory segments assigned to variables (e.g., starting addresses and sizes of allocated regions) and allocator-specific states (such as internal memory pools and free lists) associated with both the shared service memory and instance memory segments. When the node or service is restarted, the allocator is reloaded from storage, and previously allocated memory regions with the same virtual memory addresses are restored. As such, the references to allocated objects remain consistent across different executions.

A userspace paging module 348 may handle memory management within the user environment of the node. Unlike traditional paging, which relies on the operating system's kernel to manage memory pages, userspace paging module 348 may manage paging within the node's user-level environment. This means that memory pages are loaded and unloaded dynamically by the userspace paging module 348 without requiring additional support or modifications to existing kernel code of an OS. Such an approach functions within the regular application space (userspace), and leverages standard system calls and signals provided by the OS without altering or extending the underlying kernel code. This makes it highly compatible and deployable on existing operating systems like Linux, BSD, macOS, Android, and iOS. Essentially, developers do not need to modify the OS or use special kernel extensions for the userspace paging module to work. When a service attempts to access a part of memory that is not currently loaded into RAM. In response, the operating system generates a signal, such as SIGSEGV (segmentation fault) or SIGBUS, indicating an illegal memory access or misalignment. The userspace paging module 348 intercepts these signals, determines the missing page's location, and retrieves the required data either from external storage 346 or the versioned page store 344. This behavior allows the node to efficiently manage memory by only loading the necessary pages on demand. For example, if service A attempts to read or modify a part of its service memory 322 that is currently not in RAM, the userspace paging module 348 intercepts the resulting page fault and searches for the missing page within the versioned page store 326. If the page is not found, the userspace paging module 348 may retrieve it from external storage 346. This on-demand memory management ensures the node maintains a minimal memory footprint while still accessing large datasets when necessary. Further details related to the userspace paging module 348 and management of paging are discussed in further detail in accordance with FIG. 4.

In one embodiment, as illustrated in FIG. 3, only the service memory is versioned and saved to the versioned page store 326 and 344, while instance memory remains unversioned to simplify local, transient computations. However, in other embodiments, both the service memory and the instance memory may be versioned. The versioned page store 326 and 344 ensures efficient state management by tracking changes at the page level using a copy-on-write (CoW) mechanism. When a node hosting a service modifies state data, only the modified pages are saved as new versions. This incremental update process reduces storage requirements by avoiding the need to store entire datasets for every change. Additionally, the versioned page store 326 and 344 may enable rollback and recovery. If an error occurs or a node needs to revert to an earlier state, a versioned page store can retrieve a previous version from the database.

Each versioned page includes metadata, such as timestamps or version numbers, to identify the specific state captured by that version. When a rollback or recovery is needed, either due to an error or a system reset—the versioned page store can retrieve the most recent valid version of a page. For example, if a faulty transaction corrupts the service's global state, the system can discard the corrupted page and restore a previous version to maintain consistency. The pages are stored sequentially or indexed by their virtual addresses such that any modified page can be efficiently identified and retrieved without scanning the entire dataset. When new versions of a page are created through the CoW mechanism, the previous versions remain intact to maintain a complete history of changes. This history provides traceability and ensures that the state can be reconstructed accurately at any point in time.

The versioned page store 326 and 344 can be implemented using persistent databases or storage systems optimized for efficient read and write operations. For example, key-value stores may be used, where each page ID (or virtual address) hashed as the key, and the content of the page is stored as the value. The versioned page store may reside on local storage, such as an SSD or HDD attached to the node, or on remote network storage, such as a storage area network (SAN) or a network-attached storage (NAS) system.

External storage 346 further supports efficient memory management by providing long-term storage for pages that are not actively needed in RAM. For example, if certain historical transaction data or infrequently accessed account records are not immediately required, the userspace paging module 348 can offload these pages to external storage 346. When the data is needed again, the userspace paging module 348 retrieves it from external storage 346, and loads it back into RAM, and provides an uninterrupted access to state data. In various embodiments, external storage 346 can take multiple forms depending on the specific requirements of the system. For example, external storage can reside on local disks, such as solid-state drives (SSDs) or hard disk drives (HDDs) attached directly to the host machine, providing fast access with low latency. In other configurations, external storage 346 may be located on network-attached storage (NAS) or storage area networks (SAN). In cloud-based scenarios, external storage 346 can reside on cloud services, such as Amazon S3, Google Cloud Storage, or Microsoft Azure Blob Storage.

FIG. 4 illustrates an example process for handling dynamic paging through a userspace paging module 348. The example illustrated in FIG. 4 may correspond to a node 160 running instances of a service A 130 with a portion of process memory 410 allocated to the service during initialization. In this example, the service may attempt to access a variable with a specific virtual address associated with the variable. For example, the service may attempt to access a variable stored at a virtual address 0x60000042. As used herein, virtual memory addresses may refer to logical memory locations assigned by allocators to manage memory efficiently. These allocators, such as those shown as 330 and 336 in FIG. 3, function like a runtime within the sandbox environment of the Virtual Machine (VM) and handle the dynamic assignment and management of virtual addresses for each service. The allocators are designed to manage memory within the VM, and logic associated with the allocators is generated and included along with the main code running inside the VM. Since these allocators are packaged with the VM, they can be updated or customized individually for each VM instance, such that each VM can have allocators tailored to its specific needs. In one embodiment, by default, most VMs use a standard allocator, provided through a software development kit (SDK) by the disclosed decentralized platform, to handle standard memory tasks. However, this modular design provided by the platform also gives developers the option to adjust the allocator code for particular services or applications within the VM for service-specific memory management as needed.

The host operating system (OS) manages the overall allocation of memory and system resources and assigns a chunk of memory, such as process memory 410, to each application or service running on a node. This process memory acts as a dedicated space for the application to operate and is mapped to the physical memory of the machine. Within this assigned process memory 410, the disclosed memory management system may function as a “mini-OS-like” paging system. This internal userspace paging system (module 348) operates within the process memory space, whose paged memory is further subdivided and managed by allocators. These components are responsible for dynamically assigning and managing virtual addresses, handling memory paging with versioning if required, and determining which parts of memory should be active or loaded at any given time. Virtual memory addresses serve as an abstraction, mapping to the host operating system (OS) memory addresses that represent the actual physical memory locations in the machine's hardware. As the example illustrated in FIG. 4, a block of service memory 422 may be allocated from the virtual address range 0x40000000 to 0x80000000 (Virtual Address 401, 405, 403), which corresponds to host OS addresses from 0x1e30000000 to 0x1e7000000 (Host OS Address 402, 406, 404). This range of virtual addresses is initially reserved as such that it does not yet contain any active memory until required by the service.

As illustrated in FIG. 4, a solid-colored block 430 may represent a memory page that has already been retrieved from the versioned page store 426 and is currently loaded into active memory. When service A 130 requests access to a variable stored at virtual address 0x60000042, it is determined that the requested data is not present in process memory 410. Since the corresponding 4 KB page starting at virtual address 0x60000000 is not loaded, a page fault is triggered. In response, the operating system emits a SIGSEGV (segmentation fault) signal, indicating that the service has attempted to access a memory address not currently available in RAM. The userspace paging module 348 intercepts the segmentation fault signal and initiates the retrieval of the required page. The requested page, illustrated as a block 432 with diagonal lines, corresponds to the memory page starting with the virtual address 0x60000000. The userspace paging module 348 queries the versioned page store 426, which stores memory pages using the virtual address as a key and the page content as the associated value. If the required page is not found in the versioned page store 426, the userspace paging module 348 may fetch it from external storage 428. Once retrieved, the userspace paging module 348 fills the corresponding location in the memory hole with the newly loaded page such that the virtual address 0x60000000 maps correctly to its associated host OS address 406 within the reserved memory range. This dynamic paging mechanism ensures that the node maintains a minimal memory footprint by loading only the necessary pages on demand, while providing fast access to any data required by the service.

Additionally, when modifications are made to a page, the userspace paging module 348 may manage the write-back process. When a write-back operation is initiated, the process may identify any changes made to the memory pages managed by the userspace paging module 348. The userspace paging module 348 may check which pages were historically loaded in the active memory and monitor writes to addresses within these pages since the last write-back operation. In one embodiment (e.g., for operating systems or architectures that support identifying the type of access in a page fault signal, such as whether it is a read or a write), the userspace paging module may directly detect write attempts. The page may initially load as read-only, and when a write occurs, the page fault identifies it as a modification. The userspace paging module then marks the page as “dirty” (indicating it has been changed) and grants full read/write access. In another embodiment, for example, for systems that do not support this level of access detection, the userspace paging module may still track modifications by scanning through all loaded pages to check for changes since the last write-back. Furthermore, any suitable alternative methods for detecting changes may be employed as appropriate to provide flexibility in the monitoring of modifications across various environments. It should be understood that such methods are provided by way of example and not limitation, and other approaches to detect modifications may be utilized within the scope of this disclosure.

Once the modified pages are identified, the userspace paging module 348 scans these pages to detect differences between their current state and their last stored version. In one embodiment, the virtual pages are designed to be more granular in size, which enables the detection and update of only the specific portions of memory that have changed, rather than an entire larger OS-level page. Such a design reduces the amount of data that needs to be persisted and minimizes the input/output (I/O) operations involved. After identifying the changes, the userspace paging module 348 writes back only the modified pages to the versioned page store 426, where each virtual page address is used as a key, and the content of the page is stored as the value.

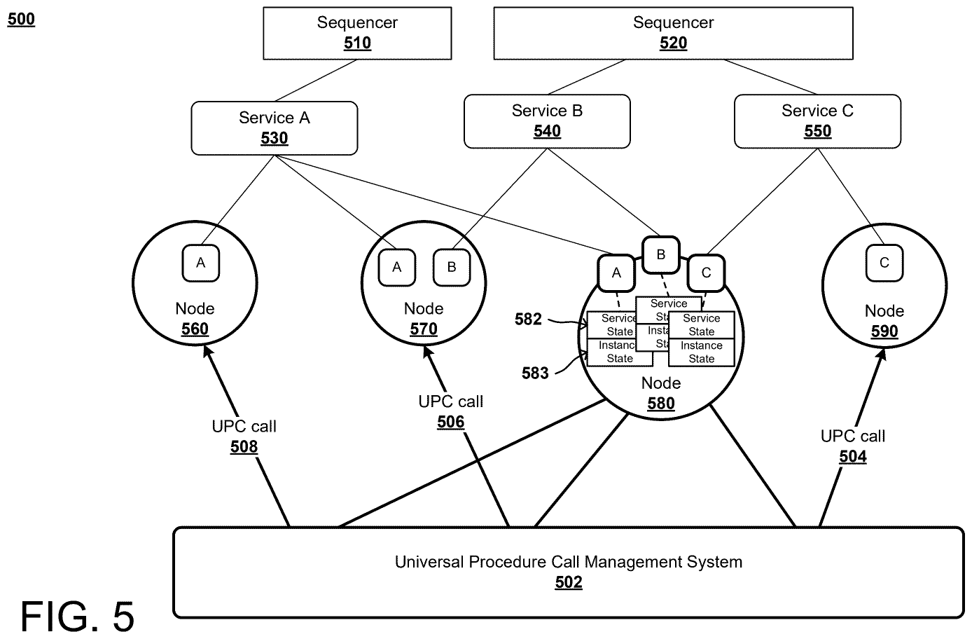

FIG. 5 illustrates an example embodiment of a universal procedure call (UPC) management system 502 that manages interactions and executes operations associated with nodes, services, and sequencers across a distributed environment 500. A UPC management system 502 may facilitate communication between nodes through UPC, which is a flexible communication framework designed to facilitate multicast-enabled interactions between nodes across a decentralized network. A UPC call can be structured as a request from one node to a subset of other nodes, including parameters such as the desired service state versions, latency constraints, or fault tolerance threshold. Including the service state version allows the UPC caller to specify which version of the service state (memory) should be used by the callee when responding. This ensures the UPC call is processed with consistent data, even when different nodes have varying versions of the service state. In financial applications, for example, a UPC call may specify that at least two-thirds of the nodes need to respond to validate a transaction. Nodes receiving the UPC call can return either partial or full results, which are then aggregated by the calling node to form a final outcome. The UPC framework enables complex operations to be partitioned across several nodes that collaborate to achieve the desired result in decentralized networks.

A UPC management system 502 may play a key role in coordinating these calls by managing the routing, aggregation, and fault tolerance settings for UPC interactions. A UPC framework, as disclosed herein, extends beyond traditional Remote Procedure Calls (RPC) by allowing nodes to exchange information both on-chain and off-chain without requiring blockchain consensus for every interaction. Through this framework, nodes can select other nodes for communication-based on operational parameters stored in their service state and instance state to achieve optimized performance and reliability.

In one embodiment, nodes may use data related to the service state and instance state to determine a subset of nodes to engage via UPC calls. The service state includes global information relevant to the execution of the service, such as transaction history, service-wide parameters, and updates affecting the behavior of all participating nodes. The service state data may also store global information associated with other nodes in the network, such as node metrics related to node reputations, performance, load distribution, or latency. A node initiating a UPC call may utilize the shared global information to intelligently route UPC calls to a selected subset of nodes. In one embodiment, UPC calls may be recursive or nested, where an initial UPC call triggers subsequent UPC calls and waits for their completion. This allows nodes responding to an initial UPC to initiate further UPCs as needed and to only finalize their response once the inner UPC calls are complete. The instance state contains session-specific data, local caches, or computation results that are private to individual nodes. The instance state data may allow each node to manage its operations independently and make decisions about which UPC calls to further issue based on its specific needs and resource availability.

To illustrate the operation of a UPC management system 502, consider the scenario depicted in FIG. 5, where node 580 acts as an initiating node issuing UPC calls to other nodes. Node 580 hosts services A 530, B 540, and C 550, each has corresponding data associated with service state 582 and instance state 583. The sequencers 510 and 520 ensure that all operations are executed in the correct order. For example, sequencer 510 manages the transaction sequence for service A, while sequencer 520 handles the operations of services B, C and D 552. In this example, node 580 may need to access service state information for a service it does not host-service D. This call may request historical trade data to collect the service state maintained by node 560 to ensure that a new transaction does not conflict with previous trades. To do this, node 580 may send a UPC call 556 to node 554, which hosts service D and maintains the relevant service state. This call allows node 580 to request specific data from node 554 related to service D, such as recent transaction details or other service-specific parameters that are essential for completing its operations or ensuring consistency across services. Node 580 may also send a UPC call 506 to node 570, which hosts both services A and B. Node 580 may request the current state of the order book from service B on node 570 to ensure that the submitted order can be executed without disrupting the market. Finally, node 580 may send a UPC call 504 to node 590, which runs service C, to obtain the latest pricing data from an external oracle.

In one embodiment, a UPC management system 502 may facilitate cross-service communication at the service level and allow nodes running different services to interact. For example, as illustrated in FIG. 5, node 590, which hosts service C, may, in certain embodiments, need to invoke operations associated with service A, which is hosted across nodes 560, 570, and 580. According to the service-level state and operational logic defined by service A, node 590 is directed to multicast its request to all nodes hosting service A (i.e., nodes 560, 570, and 580). This multicast approach enables node 590 to receive responses from multiple nodes hosting service A and provides redundancy that enhances fault tolerance. Such redundancy ensures that consistent results are obtained even if one of the nodes fails to respond or is delayed. This interaction is made possible by the inherent logic within each service, which enables nodes to determine the appropriate targets for UPC calls dynamically. For example, service A on node 580 may be programmed with the capability to initiate requests to service B on node 570 if additional data is needed for an operation. Accordingly, such a UPC system may enable dynamic virtual clusters of nodes and allow services to locate and interact with supporting nodes as needed. In such a framework, nodes like node 580 can participate simultaneously in multiple virtual clusters (e.g., services A, B, and C). The decision to communicate with specific nodes, such as 570, may be guided by both service-level and instance-level states on each participating node.

These capabilities are made possible by the functionalities provided by a disclosed decentralized system. The UPC management system 502 allows nodes to dynamically perform functions and operations based on their service state and instance state. In one embodiment, node 580 determines which nodes to contact based on criteria stored in the service state of each relevant service or the instance state private to each node making the call. For example, service state 582 may store load metrics, latency data, response times, trust scores, or node availability, which may help node 580 identify the most reliable nodes to send UPC calls. Nodes with lighter workloads or better recent performance metrics may be prioritized to reduce the chances of encountering bottlenecks or delays. Conversely, if a service has experienced high demand or network instability, node 580 may choose to route requests to redundant nodes or nodes with backup service instances, enhancing fault tolerance. Furthermore, the UPC management system 502 may enable the creation of virtual clusters for each service such that nodes that host a particular service to act as a unified group (e.g., virtual cloud). Nodes can join or leave a service's cluster as needed, with each node simultaneously able to participate in multiple such clusters. This flexibility allows each service to function as an abstracted network of nodes, with the UPC system dynamically routing calls to relevant nodes within these virtual clusters. Such a design enables efficient load distribution, reduces latency, ensures robust fault tolerance, and allows such a system to adapt in real-time to changing workloads and network conditions.

In one embodiment, the number of nodes selected to receive UPC calls can depend on the nature and importance of the operation. Disclosed methods and approaches enable nodes to adjust the number of recipients based on the importance of the operation. For high-stakes operations, such as finalizing a financial transaction or executing an important trade, node 580 may issue calls to multiple nodes to ensure that the result is reliable and consistent. For example, it may require a two-thirds quorum of nodes to respond with consistent data before proceeding. For less critical operations, such as retrieving historical data or pricing information, node 580 may send the call to fewer nodes or rely on the first valid response to reduce latency.

A UPC management system 502 also provides nodes with mechanisms to evaluate the trustworthiness of responses. In one embodiment, the evaluation is guided by the service-defined logic embedded within each service, and the UPC management system 502 on each node carries out this evaluation based on the specific logic of the service. To determine whether the information received from other nodes meets a threshold of trust, a UPC management system 502 may analyze consistency across multiple responses. If several nodes return identical or closely aligned data, the information can be considered reliable according to the logic defined by the service. However, if discrepancies arise, node 580 may rely on trust metrics associated with each node, such as historical accuracy, latency, or uptime, to weigh responses. In some scenarios, node 580 may discard outlier responses or reissue the call to other nodes to improve the reliability of the result. Such a process supports cross-validation by comparing responses from multiple nodes for consistency, ensures fault tolerance by allowing the system to function despite potential errors, and facilitates result aggregation by combining data from different sources.

In one embodiment, trustworthiness may be established through methods of self-validation. For example, in scenarios where the data itself is inherently verifiable, such as by cryptographic hashing or checksums, redundancy may serve to ensure availability rather than consistency validation. For example, in a video streaming scenario, data chunks may be verified independently through cryptographic digest algorithms (e.g., SHA-256 or Blake2), which allows the node to confirm data integrity without requiring multiple responses from separate nodes.

Additionally, the UPC management system 502 supports cryptographic protocols that naturally align with a decentralized trust model using methods that do not rely on traditional cross-validation. For example, a Verifiable Random Function (VRF) may allow the majority of the network to securely and collaboratively determine a random number, which provides a trusted outcome without requiring further consistency checks. Similarly, Multi-Party or Threshold Signing schemes may require a quorum of nodes to sign or approve a transaction to establish the operation's integrity and consistency across the network. In one embodiment, Multi-Party Computation (MPC) enables nodes to jointly compute an output without exposing their individual inputs, which enables privacy-preserving data validation across multiple nodes while achieving a reliable result. As such, the UPC management system 502 provides a flexible and adaptable framework for trust assessment and enables nodes to validate responses in ways tailored to specific service requirements.

A UPC management system 502 manages the complexity of inter-node communication such that nodes receive and respond to UPC requests in a fault-tolerant and adaptive manner. In scenarios where a node fails to respond to a UPC call, the UPC management system 502 may dynamically reissue the request to another node, adjust the consistency threshold, or allow the operation to proceed with fewer participants while maintaining integrity. The flexibility of the UPC framework allows smooth collaboration between nodes and supports interaction across nodes running different services. For example, node 580 can efficiently interact with other nodes that host services A, B, or C, issuing UPC calls without needing to route requests through a blockchain. Such a UPC management system 502 ensures that nodes can communicate directly, whether the task involves data retrieval, transaction validation, order matching, or multi-party computation (MPC). Through this architecture, nodes can maintain a high level of trust, efficiency, and performance across a distributed network, which lead, to the smooth operation of decentralized applications.

In one embodiment, a bootstrap process can be implemented for newly joined nodes to acquire up-to-date service state directly from existing nodes. This mechanism allows a new node to request and obtain a valid state image from nodes that already maintain the service state, along with proofs or checksums to guarantee the data integrity. Such checksums or validity proofs can be posted in the sequence to confirm the authenticity of the state image. The new node can utilize a UPC call to inquire about and receive the relevant state image and allow it to start participating in operations without needing to replay all historical transactions or operations from scratch.

In one embodiment, such a bootstrap process leverages sequence checkpoint information provided by a sequencer, which includes essential data such as code checkpoints and state checkpoints. These checkpoints encapsulate the current service-level state and enable nodes to synchronize efficiently without replaying all historical transactions or operations from scratch. The sequencer posts cryptographic proofs, such as hashes, to verify the validity of this state data. When a new node joins the network, it can retrieve checkpoint information and associated proofs from the sequencer to ensure that the state it receives is current and accurate. The new node can then utilize the UPC system to request the relevant state image from existing nodes. By sending UPC calls to multiple nodes, the new node can cross-verify the data it receives, using the sequencer-provided proofs to validate the integrity and authenticity of the information. This ensures that the state image obtained is trustworthy.

Additionally, such a decentralized platform may provide services that manage special services such as catalog services that store metadata related to the nodes and services in the decentralized network. These platform-managed services may maintain a comprehensive catalog of which nodes are active, the services they host, and which sequencers manage specific services. Such a service may enable nodes to discover and interact with other services efficiently. By contacting the catalog service, a node can quickly determine which other nodes are hosting the required services, as well as access detailed information about service distribution and their respective sequencers.

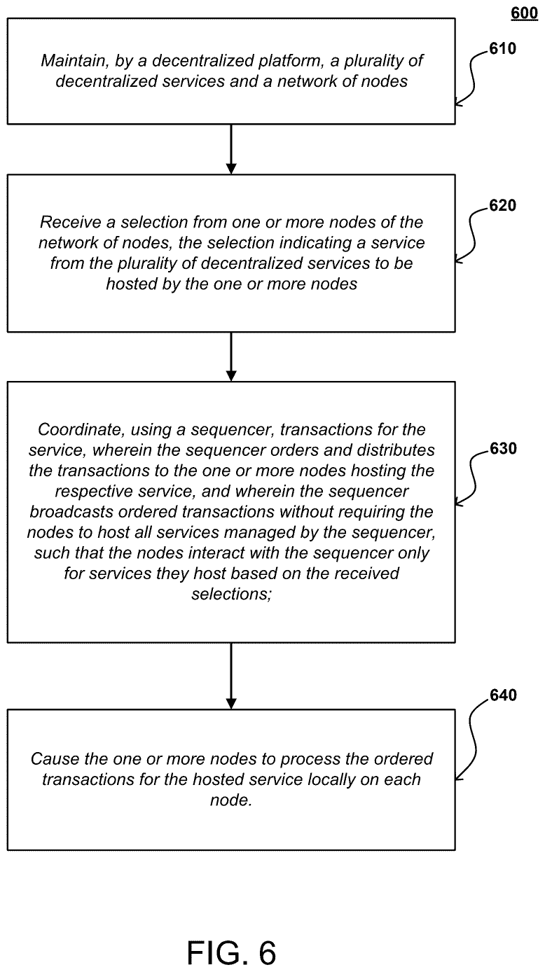

FIG. 6 illustrates a flowchart depicting an example process 600 by which a decentralized platform coordinates transaction processing across a network of nodes. Such a process enables efficient and scalable service management by distributing tasks to nodes hosting specific services and ensuring consistency through a sequencer.

A decentralized platform maintains 610 a plurality of decentralized services and a network of nodes. Each service may represent a decentralized application or workload that performs specific functions. These services are distributed across multiple nodes which are the computational hosts that run instances of the services, with each node only responsible for the services it selects.

A selection may be received 620 from one or more nodes in the network, indicating which services the nodes will host. Each node can subscribe to one or more services based on factors, such as available storage, available resources, network load, computational power, or the service incentives it wishes to pursue.

Transactions for a service may be coordinated 630 using a sequencer. The sequencer may order and distribute the ordered transactions to the nodes hosting the corresponding services. A sequencer broadcasts ordered transactions without requiring the nodes to host all services managed by the sequencer, such that the nodes interact with the sequencer only for services they host based on the received selections.

The participating nodes are caused 640 to process the ordered transactions locally within each service they host. Each node executes the transactions associated with its subscribed services without being required to download or process transactions related to other services managed by the same sequencer to which the node has not subscribed.

FIG. 6 illustrates a flowchart depicting the process 600 of managing persistent virtual memory across a network of nodes. The process 600 may begin with step 610, where one or more decentralized services are executed on a virtual machine distributed across multiple nodes. Each node participates in the execution of these services, with the service state distributed across the participating nodes. Each node may maintain 620 a shared memory segment within persistent virtual memory to store variables associated with the service-level state. The service-level state includes data that must be consistent and synchronized across multiple nodes participating in the same service. The platform ensures that the shared memory segment is synchronized across nodes hosting the service such that all participants have a consistent view of the service state eventually.

Each node also maintains 630 an instance memory segment within the persistent virtual memory. Unlike shared memory, instance memory is private to each node and not synchronized across the network. This memory segment stores instance-level states, such as temporary calculations, local caches, or intermediate data used exclusively by the node during its operations.

Memory pages are dynamically loaded 640 from non-volatile storage device to the node's volatile OS memory in response to access requests, which all occur within userspace. The non-volatile external storage may include devices such as hard drives, SSDs, or cloud-based storage systems, which store large datasets that are not actively needed in RAM. When a service or node attempts to access data that is not currently available in the OS memory, the userspace memory management system triggers a page fault and retrieves the relevant memory page from external storage. This on-demand paging mechanism within the userspace ensures that only the necessary pages are loaded into volatile memory and allows the platform to maintain a minimal memory footprint while still accessing large datasets when needed. Such an approach provides a technical advantage over traditional virtual machine hypervisors or kernel-level memory management, which need kernel permissions or run directly as an OS layer on hardware. In contrast, such an approach can operate as a regular application within userspace, which simplifies deployment and increases cross-platform portability (e.g., easily used across different types of operating systems or hardware platforms without requiring significant changes.) The on-demand paging system only loads the memory pages that are necessary and allows the platform to use RAM efficiently and maintain a minimal memory footprint while still being able to access large datasets when needed.

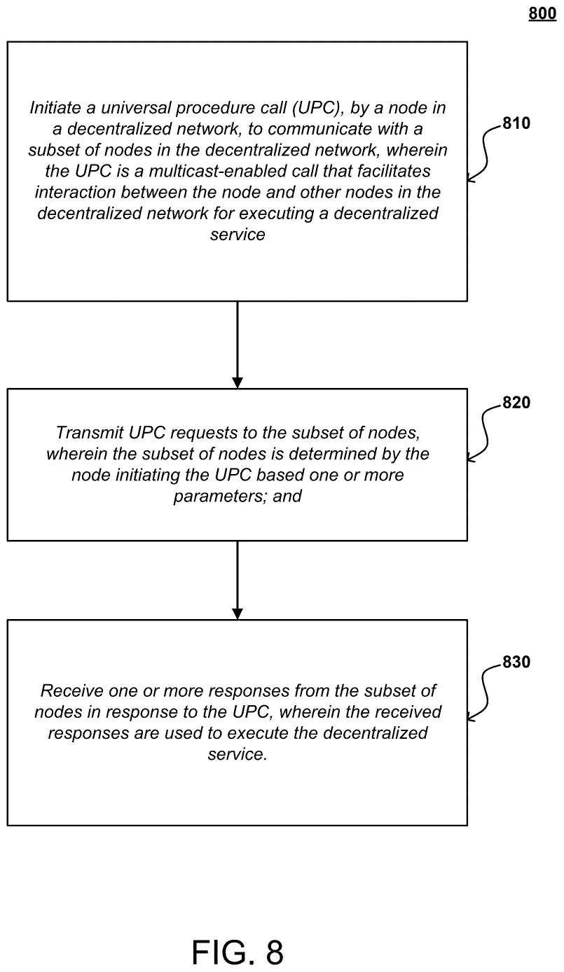

FIG. 8 depicts a flowchart 800 illustrating the steps involved in using a universal procedure call (UPC) to facilitate multicast-enabled communication between nodes in a decentralized network.

A node in the decentralized network may initiate 810 a Universal Procedure Call (UPC) to communicate with a subset of nodes within the network. The UPC call enables interaction between nodes by allowing them to exchange information and coordinate operations required for the execution of a decentralized service. The UPC framework acts as a multicast-enabled extension of traditional RPCs and allows the initiating node to issue requests that can be distributed to multiple target nodes.

The initiated UPC is transmitted 820 to the subset of nodes selected by the initiating node. The subset of nodes is determined based on parameters specified by the initiating node, such as availability, latency, trust scores, or workload distribution. The parameters used for node selection may also account for trust thresholds to ensure that data returned from other nodes is reliable. In some cases, the subset may vary dynamically, with the selection adjusted based on network conditions, node responsiveness, or operational priorities.

Once the UPC requests are transmitted, the participating nodes receive the request and respond accordingly. In step 830, the initiating node receives one or more responses from the subset of nodes. These responses may contain aggregated data, partial computations, or confirmations needed to execute the decentralized service. For example, in a multi-party computation, the initiating node aggregates the partial results from several nodes to form a final output. The responses are then used by the initiating node to complete the requested operation and ensure the decentralized service functions as intended. If discrepancies arise between responses—for example, if nodes return conflicting results—the initiating node may rely on pre-configured trust metrics or quorum thresholds to determine the correct outcome. The UPC framework ensures that even if one or more nodes fail to respond, the process can proceed with available responses or reissue the UPC call to additional nodes as needed. Such a process ensures that decentralized services can operate efficiently, with nodes coordinating dynamically to perform complex tasks, such as real-time trading, data retrieval, and distributed computations, while maintaining trust and scalability across the network.

In one embodiment, a decentralized computing platform operates by first receiving, from one or more sequencer components, a globally ordered sequence of transactions. Each transaction corresponds to a particular decentralized service, and the ordering supplied by the sequencer establishes a deterministic causal sequence in which all transactions must be processed. As the ordered sequence is received, the platform records dependency information that identifies which transactions depend on others, enabling the system to understand their causal relationships and execution constraints. The sequencer components then distribute only the relevant subset of the ordered transactions to the nodes that host the corresponding decentralized services, so that each node receives the portion of the global sequence applicable to the services it operates. The platform causes these nodes to execute the transactions they receive in the precise order assigned in the global sequence and in a manner consistent with the previously recorded dependency information, ensuring that all nodes progress deterministically even when executing different subsets of the overall workload.

In one embodiment, a node in a decentralized computing platform executes operations of one or more decentralized services inside a virtual execution environment that spans multiple participating nodes. The node maintains a persistent virtual memory that contains a shared memory segment, which stores variables that represent the service-level state of a decentralized service. This shared memory segment is synchronized only among the nodes that host that service, allowing those nodes to maintain a consistent view of the service-level state as it evolves. The same persistent virtual memory also contains an instance memory segment, which stores variables associated with instance-level state that is local to the node. The instance memory segment is private and not shared or synchronized with other nodes, allowing each node to maintain its own execution context. When the node needs access to additional state, it dynamically loads one or more memory pages from a non-volatile storage system into the persistent virtual memory. The loaded pages may correspond to any portion of the service-level state or the instance-level state required to process the current access request. This arrangement enables decentralized services to execute deterministically across multiple nodes while supporting efficient, on-demand retrieval of the state required by each node's local execution environment.

### Example Applications

In one example use case, approaches in accordance with one or more disclosed embodiments may enable DeFi applications by decoupling transaction sequencing from execution. Services such as decentralized exchanges (DEXs) can perform high-frequency trades without encountering the bottlenecks associated with network-wide replication. Each DeFi service operates independently, with nodes subscribing based on their resources and preferences to execute trades and maintain order books. The sequencer component orders and notarizes transactions according to service-specific rules (e.g., matching buy/sell orders), but only participating nodes process these transactions locally. This selective engagement prevents all nodes from redundantly executing every trade. Through the UPC framework, multiple nodes may be engaged during order matching, aggregating their responses to establish consistency more efficiently than traditional blockchain-based models. This ability to configure fault tolerance by involving more nodes as needed introduces an elastic trust model. The elastic trust paradigm enables developers to balance between decentralization, performance, and security by dynamically determining how many nodes participate in specific operations based on the task's criticality. For example, higher-value trades or sensitive operations may require responses from a larger quorum of nodes, increasing redundancy and ensuring more robust security guarantees. In contrast, less critical operations may involve fewer nodes, focusing on performance without compromising trust. The persistent virtual memory system further ensures that transaction execution remains fast and efficient by eliminating the need for repeated serialization and deserialization of state data. Instead, only relevant memory pages are loaded on demand, allowing nodes to execute trades with minimal latency. This architecture, combined with elastic trust and customizable UPC calls, enables the platform to achieve both high-speed execution and adaptive security, meeting the specific needs of different DeFi services without the rigidity of traditional blockchain architectures.

In a decentralized content delivery network (CDN) scenario, nodes across the network can cache and serve content dynamically and subscribe to services based on their storage capacity and bandwidth availability. The UPC framework allows multiple nodes to receive and respond to the same content request, with responses aggregated to ensure data consistency and availability. This aggregation mechanism ensures that even if some nodes experience delays or outages, the content remains accessible from other active nodes, reducing the risk of disruptions typically seen in centralized systems. Nodes hosting CDN services benefit from the platform's persistent virtual memory system, which maintains cached content in memory across sessions and enables quick retrieval. For example, traditional CDNs may rely on a limited number of centralized servers strategically placed in specific geographic locations. While effective, existing implementations can be constrained by the number and distribution of these servers. In contrast, a decentralized CDN as disclosed herein may incentivize local nodes to join the network and allow them to host and deliver content closer to user locations. For example, if a user in a remote town wants to access a video, a local node can join the network and start caching and delivering that content to reduce the distance data must travel and thus improving response times. This encourages more users to participate in the network, especially those with suitable equipment such as home servers or high-capacity computers. Such a decentralized architecture supports a broader distribution of nodes, which translates into more points of presence across different regions. This increased availability helps ensure that content remains accessible even if some nodes face disruptions or go offline. For example, if a major city experiences an outage affecting traditional CDN servers, a decentralized CDN as disclosed herein can continue serving content through nearby local nodes that are still operational. This architecture prevents single points of failure and improves fault tolerance, as content requests can be fulfilled by multiple active nodes spread throughout the network.

For AI-related workloads, such as model training or inference, nodes with GPU resources selectively join services that require significant computational power. Unlike traditional centralized AI platforms, approaches in accordance with a disclosed decentralized system allow multiple nodes to collaborate on AI tasks without being bound to a monolithic framework. In one embodiment, approaches in accordance with a disclosed decentralized system connect existing AI pipelines using a combination of persistent virtual memory and the UPC framework. This means that machines already running AI tasks, which might be designed for single-machine or local environments, can be connected to the decentralized network without significant changes to their original configuration. For example, existing AI programs may be packaged as “blackbox” units, such as Docker container images, which include all the necessary code and dependencies for the AI task. These containerized units are then bundled with the platform's service code, which takes care of networking, orchestration, and management functions. The service code coordinates communication between nodes and allows them to interact as part of a larger virtual cloud. This approach makes it possible to leverage the computing power of multiple nodes and distribute the workload across the network without needing to rewrite or extensively modify the existing AI programs. As such, approaches in accordance with a disclosed decentralized system allow a decentralized system to “glue” together different machines running AI workloads into a cohesive, collaborative environment.

In another embodiment, approaches in accordance with a disclosed decentralized system provide built-in functions for common GPU-driven operations within its service code. This allows developers to define and execute AI model training or inference directly within the decentralized network through services, without the need for external tools or separate execution environments. By incorporating these operations as built-in functions, developers can write service code that describes the entire logic for training or using an AI model within the system itself. This integration simplifies the development process and ensures that the entire AI workflow can be managed within the platform to provide a unified approach to decentralized AI processing.

A persistent virtual memory system disclosed herein may handle large model parameters and allow these large shards of model data to be stored and accessed quickly, without needing to use slower disk-based storage. When processing, the necessary model parameters are loaded into the GPU's memory for computation. Each node can keep parts of the model in its instance-level memory to maintain and manage its state efficiently throughout multiple computation steps. For example, the model parameters may be managed at the instance level by splitting them into smaller pieces, called “shards.” These shards are distributed across different nodes, with built-in redundancy to ensure data availability and reliability. This sharding process is managed by the platform's service-level metadata and logic, which coordinate how the model parameters are stored, retrieved, and kept consistent across the network. This design helps nodes store large models efficiently and ensures that even if some nodes become unavailable, the data remains accessible. This setup replaces traditional cloud storage systems, like Amazon S3, by offering a more integrated and faster solution.

In another embodiment, the disclosed platform may facilitate coordination of general-purpose computational services and enable distributed execution of workloads that may include, but are not limited to, artificial intelligence inference, data processing, analytics, or scientific simulation. Service provider nodes host computational services and define service interfaces through the global service registry. Consumer nodes or other services may issue requests to service interfaces along with input parameters and an execution context. The requests are routed to appropriate provider nodes, which execute the corresponding computations within isolated runtimes. In some embodiments, on-chain metadata associated with such requests, such as service identifiers, version commitments, data source references, or payment state, may be incorporated into the global Fate-Constrained Ordering (FCO) sequence. The FCO assigns a fate index and captures dependency metadata such as service version, data source, and payment state, ensuring globally consistent ordering and deterministic replay across the network. The invocation is delivered to the appropriate provider node according to the UPC routing configuration. The provider executes the computation off-chain within an isolated runtime. During execution, service-level and instance-level state are maintained in userspace persistent virtual memory. This allows the system to record precise state transitions for the invocation, providing deterministic reproducibility and efficient snapshotting without reloading unrelated memory regions. In the case of an artificial-intelligence workload, for example, model parameters and execution context may be memory-mapped and versioned so that the exact inference can later be verified or re-executed from the recorded state. Upon completion, the provider generates an output digest that represents the computation result and its version dependencies. The digest, along with billing metadata, is submitted to the on-chain settlement service, which verifies the result against the fate sequence before releasing payment from the consumer to the provider. Intensive computation and data transfer remain off-chain for performance and scalability, while ordering, verification, and payment finality are managed on-chain for accountability and trust minimization. Through this hybrid coordination model, the platform supports deterministic, verifiable, and economically enforceable execution of arbitrary off-chain computations within a decentralized architecture.

### Example—Distributed LLM Inference Cluster

In another example embodiment, the platform may be used to coordinate a distributed cluster for large-language-model (LLM) inference. A decentralized service may define the cluster-management logic, including rules for node membership, role assignment, reconfiguration, and reward or penalty conditions. When a node joins or leaves the cluster, the corresponding event is submitted to the sequencing component and incorporated into the global fate sequence. Because all nodes process the same ordered events, each node computes identical updates to the service's network-level state, which records the current cluster composition and the roles assigned to participating nodes. Each node uses this service-level state to derive its own instance-level state and configure a local AI runtime. This runtime is responsible for loading model parameters, handling inference requests, and performing any role-specific tasks such as routing, batching, or partial computation. The inference workload executes entirely within the node's local environment, while the service's on-chain state transitions determine how the cluster should reorganize when nodes join, leave, or change roles. By relying on the fate-ordered state transitions, all nodes independently arrive at the same cluster configuration without directly coordinating with one another. This allows the system to operate as a self-adjusting, multi-node inference cluster in which orchestration logic is deterministic and globally consistent, while computation remains off-chain for performance.

### Computer Systems

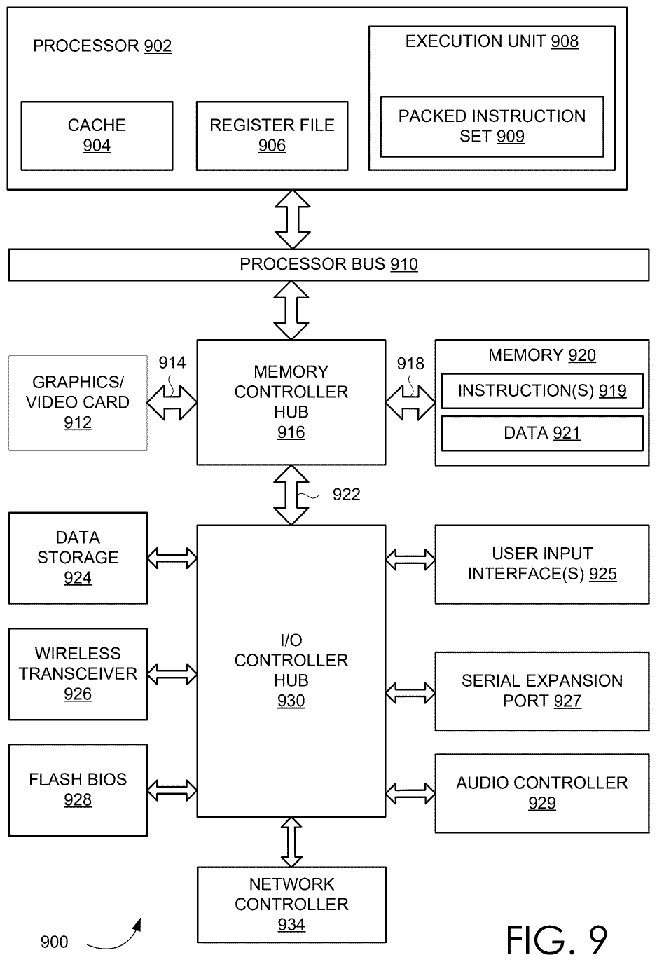

FIG. 9 is a block diagram illustrating an exemplary computer system, which may be a system with interconnected devices and components, a system-on-a-chip (SOC) or some combination thereof 900 formed with a processor that may include execution units to execute an instruction, according to at least one embodiment. In at least one embodiment, computer system 900 may include, without limitation, a component, such as a processor 902 to employ execution units including logic to perform algorithms for process data, in accordance with present disclosure, such as in embodiment described herein. In at least one embodiment, computer system 900 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 900 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), a system on a chip, network computers (“NetPCs”), set-top boxes, network hubs, wide area network (“WAN”) switches, or any other system that may perform one or more instructions in accordance with at least one embodiment.

In at least one embodiment, computer system 900 may include, without limitation, processor 902 that may include, without limitation, one or more execution units 908 to perform machine learning model training and/or inferencing according to techniques described herein. In at least one embodiment, computer system 900 is a single processor desktop or server system, but in another embodiment, computer system 900 may be a multiprocessor system. In at least one embodiment, processor 902 may include, without limitation, a complex instruction set computing (“CISC”) microprocessor, a reduced instruction set computing (“RISC”) microprocessor, a very long instruction word (“VLIW”) computing microprocessor, a processor implementing a combination of instruction sets, or any other processor device, such as a digital signal processor, for example. In at least one embodiment, processor 902 may be coupled to a processor bus 910 that may transmit data signals between processor 902 and other components in computer system 900.

In at least one embodiment, processor 902 may include, without limitation, a Level 1 (“L1”) internal cache memory (“cache”) 904. In at least one embodiment, processor 902 may have a single internal cache or multiple levels of internal cache. In at least one embodiment, cache memory may reside external to processor 902. Other embodiments may also include a combination of both internal and external caches depending on particular implementation and needs. In at least one embodiment, register file 906 may store different types of data in various registers including, without limitation, integer registers, floating point registers, status registers, and instruction pointer registers.

In at least one embodiment, execution unit 908, including, without limitation, logic to perform integer and floating point operations, also resides in processor 902. In at least one embodiment, processor 902 may also include a microcode (“ucode”) read only memory (“ROM”) that stores microcode for certain macro instructions. In at least one embodiment, execution unit 908 may include logic to handle a packed instruction set 909. In at least one embodiment, by including packed instruction set 909 in an instruction set of a general-purpose processor 902, along with associated circuitry to execute instructions, operations used by many multimedia applications may be performed using packed data in a general-purpose processor 902.

In at least one embodiment, execution unit 908 may also be used in microcontrollers, embedded processors, graphics devices, DSPs, and other types of logic circuits. In at least one embodiment, computer system 900 may include, without limitation, a memory 920. In at least one embodiment, memory 920 may be implemented as a Dynamic Random Access Memory (“DRAM”) device, a Static Random Access Memory (“SRAM”) device, flash memory device, or other memory device. In at least one embodiment, memory 920 may store instruction(s) 919 and/or data 921 represented by data signals that may be executed by processor 902.

In at least one embodiment, system logic chip may be coupled to processor bus 910 and memory 920. In at least one embodiment, system logic chip may include, without limitation, a memory controller hub (“MCH”) 916, and processor 902 may communicate with MCH 916 via processor bus 910. In at least one embodiment, MCH 916 may provide a high bandwidth memory path 918 to memory 920 for instruction and data storage and for storage of graphics commands, data and textures. In at least one embodiment, MCH 916 may direct data signals between processor 902, memory 920, and other components in computer system 900 and to bridge data signals between processor bus 910, memory 920, and a system I/O 922. In at least one embodiment, system logic chip may provide a graphics port for coupling to a graphics controller. In at least one embodiment, MCH 916 may be coupled to memory 920 through a high bandwidth memory path 918 and graphics/video card 912 may be coupled to MCH 916 through an Accelerated Graphics Port (“AGP”) interconnect 914.

In at least one embodiment, computer system 900 may use system I/O 922 that is a proprietary hub interface bus to couple MCH 916 to I/O controller hub (“ICH”) 930. In at least one embodiment, ICH 930 may provide direct connections to some I/O devices via a local I/O bus. In at least one embodiment, local I/O bus may include, without limitation, a high-speed I/O bus for connecting peripherals to memory 920, chipset, and processor 902. Examples may include, without limitation, an audio controller 929, a firmware hub (“flash BIOS”) 928, a wireless transceiver 926, a data storage 924, user input and keyboard interfaces 925, a serial expansion port 927, such as Universal Serial Bus (“USB”), and a network controller 934. Data storage 924 may comprise a hard disk drive, a floppy disk drive, a CD-ROM device, a flash memory device, or other mass storage device.

In at least one embodiment, FIG. 9 illustrates a system, which includes interconnected hardware devices or “chips”, whereas in other embodiments, FIG. 9 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 900 are interconnected using compute express link (CXL) interconnects.

Various embodiments can be described by the following clauses:
Clause 1. In some embodiments, a computer-implemented method comprises receiving, from one or more sequencer components, a globally ordered sequence associated with a plurality of transactions, each transaction associated with a service of a plurality of decentralized services, the globally ordered sequence defining a deterministic causal order of execution among the plurality of transactions; recording dependency information representing causal relationships between the plurality of transactions; distributing, through the one or more sequencer components, a respective subset of the globally ordered sequence of transactions to one or more nodes that host corresponding decentralized services; and causing the one or more nodes to execute the distributed transactions in accordance with their positions in the globally ordered sequence and in conformity with the recorded dependency information.
Clause 2. The computer-implemented method of clause 1, wherein a decentralized computing platform manages the plurality of decentralized services and manages the one or more nodes that host the corresponding decentralized services, wherein the decentralized computing platform further comprises one or more archival nodes, each archival node maintaining a complete record of the globally ordered sequence and corresponding dependency information, and wherein the a node obtains ordering information from at least one archival node and verify completion of a transaction that depends on another transaction prior to local execution of the transaction.
Clause 3. The computer-implemented method of clause 1 or 2, further comprising: causing the one or more nodes to identify transactions that are independent based on the recorded dependency information; causing the one or more nodes to execute the identified independent transactions in parallel; and causing the one or more nodes to defer execution of a particular transaction having unresolved dependencies until completion of one or more corresponding transactions that the particular transaction depends on.
Clause 4. The computer-implemented method of any of clauses 1-3, further comprising: receiving a selection from a corresponding node of the one or more nodes, the selection identifying one or more decentralized services from the plurality of decentralized services to be hosted by the corresponding node; and registering, by the decentralized computing platform, the received selection.
Clause 5. The computer-implemented method of any of clauses 1-4, wherein the selection received from the corresponding node is determined based on one or more operational factors including available computing resources of each participating node, hardware capabilities of the participating node, and reward associated with hosting the corresponding decentralized service, and wherein the corresponding node adjusts its hosted decentralized services in response to changes in the operational factors.
Clause 6. The computer-implemented method of any of clauses 1-5, wherein each decentralized service maintained by the decentralized computing platform comprises: a service-level state shared among the one or more nodes that host the service and storing information relevant to all instances of the service, including at least one of account data, transaction history, or other globally synchronized parameters; and an instance-level state private to each respective node and storing information specific to that node, including at least one of intermediate computation results, cache data, or session-specific parameters.
Clause 7. The computer-implemented method of any of clauses 1-6, further comprising: receiving, by the decentralized computing platform, a request from a node to communicate with a subset of nodes using a universal procedure call (UPC), the UPC being a multicast-enabled communication procedure configured for synchronized interaction among nodes; causing the node to transmit one or more UPC calls to the subset of nodes; and causing the node to receive one or more responses from the subset of nodes in response to the one or more UPC calls.
Clause 8. The computer-implemented method of any of clauses 1-7, wherein the subset of nodes is selected based on one or more parameters associated with both a service-level state shared among the one or more nodes that host the service and an instance-level state private to each respective node, the one or more parameters comprising: a required threshold for the number of responses before ending the call, a number of participating nodes, fault tolerance settings for the executing the service, network latency, the current load of the nodes, node reliability, and resource availability.
Clause 9. The computer-implemented method of any of clauses 1-8, further comprising: determining a consolidated result by aggregating the received one or more responses and wherein causing the node to execute one or more transactions associated with a decentralized service is based on the consolidated result.
Clause 10. The computer-implemented method of any of clauses 1-9, wherein the consolidated result is validated against one or more predefined consensus or correctness rules, wherein the consolidated result conforms to the dependency information and the deterministic causal order specified in the global ordered sequence.
Clause 11. In some embodiments, a system comprises one or more processors; and one or more memory devices storing instructions that, when executed by the one or more processors, cause the system to: receive, from one or more sequencer components, a globally ordered sequence associated with a plurality of transactions, each transaction associated with a service of a plurality of decentralized services, the globally ordered sequence defining a deterministic causal order of execution among the plurality of transactions; record dependency information representing causal relationships between the plurality of transactions; distribute, through the one or more sequencer components, a respective subset of the globally ordered sequence of transactions to one or more nodes that host corresponding decentralized services; and cause the one or more nodes to execute the distributed transactions in accordance with their positions in the globally ordered sequence and in conformity with the recorded dependency information.
Clause 12. The system of clause 11, wherein a decentralized computing platform manages the plurality of decentralized services and manages the one or more nodes that host the corresponding decentralized services, wherein the decentralized computing platform further comprises one or more archival nodes, each archival node maintaining a complete record of the globally ordered sequence and corresponding dependency information, and wherein the a node obtains ordering information from at least one archival node and verify completion of a transaction that depends on another transaction prior to local execution of the transaction.
Clause 13. The system of clauses 11 or 12, wherein the instructions further cause the system to: cause the one or more nodes to identify transactions that are independent based on the recorded dependency information; cause the one or more nodes to execute the identified independent transactions in parallel; and cause the one or more nodes to defer execution of a particular transaction having unresolved dependencies until completion of one or more corresponding transactions that the particular transaction depends on.
Clause 14. The system of any of clauses 11-13 wherein the instructions further cause the system to: receive a selection from a corresponding node of the one or more nodes, the selection identifying one or more decentralized services from the plurality of decentralized services to be hosted by the corresponding node; and register, by the decentralized computing platform, the received selection.
Clause 15. The system of any of clauses 11-14, wherein the selection received from the corresponding node is determined based on one or more operational factors including available computing resources of each participating node, hardware capabilities of the participating node, and reward associated with hosting the corresponding decentralized service, and wherein the corresponding node adjusts its hosted decentralized services in response to changes in the operational factors.
Clause 16. The system of any of clauses 11-15, wherein each decentralized service maintained by the decentralized computing platform comprises: a service-level state shared among the one or more nodes that host the service and storing information relevant to all instances of the service, including at least one of account data, transaction history, or other globally synchronized parameters; and an instance-level state private to each respective node and storing information specific to that node, including at least one of intermediate computation results, cache data, or session-specific parameters.
Clause 17. The system of any of clauses 11-16, wherein the instructions further cause the system to: receive, by the decentralized computing platform, a request from a node to communicate with a subset of nodes using a universal procedure call (UPC), the UPC being a multicast-enabled communication procedure configured for synchronized interaction among nodes; cause the node to transmit one or more UPC calls to the subset of nodes; and cause the node to receive one or more responses from the subset of nodes in response to the one or more UPC calls, wherein the subset of nodes is selected based on one or more parameters associated with both a service-level state shared among the one or more nodes that host the service and an instance-level state private to each respective node, the one or more parameters comprising: a required threshold for the number of responses before ending the call, a number of participating nodes, fault tolerance settings for the executing the service, network latency, the current load of the nodes, node reliability, and resource availability.
Clause 18. In some embodiments, a non-transitory computer-readable medium stores instructions that, when executed by one or more processors, cause the processors to perform operations comprising: receiving, from one or more sequencer components, a globally ordered sequence associated with a plurality of transactions, each transaction associated with a service of a plurality of decentralized services, the globally ordered sequence defining a deterministic causal order of execution among the plurality of transactions; recording dependency information representing causal relationships between the plurality of transactions; distributing, through the one or more sequencer components, a respective subset of the globally ordered sequence of transactions to one or more nodes that host corresponding decentralized services; and causing the one or more nodes to execute the distributed transactions in accordance with their positions in the globally ordered sequence and in conformity with the recorded dependency information.
Clause 19. The non-transitory computer-readable medium of clause 18, wherein a decentralized computing platform manages the plurality of decentralized services and manages the one or more nodes that host the corresponding decentralized services, wherein the decentralized computing platform further comprises one or more archival nodes, each archival node maintaining a complete record of the globally ordered sequence and corresponding dependency information, and wherein the a node obtains ordering information from at least one archival node and verify completion of a transaction that depends on another transaction prior to local execution of the transaction.
Clause 20. The non-transitory computer-readable medium of clause 18 or 19, wherein the operations further comprise: causing the one or more nodes to identify transactions that are independent based on the recorded dependency information; causing the one or more nodes to execute the identified independent transactions in parallel; and causing the one or more nodes to defer execution of a particular transaction having unresolved dependencies until completion of one or more corresponding transactions that the particular transaction depends on.
Clause 21. In some embodiments, a computer-implemented method comprises executing, by a node of a plurality of nodes, operations of one or more decentralized services within a virtual execution environment instantiated across the plurality of nodes; maintaining, by the node, in a persistent virtual memory, a shared memory segment that stores one or more variables associated with a service-level state of at least one decentralized service, the shared memory segment is synchronized among a subset of the plurality of nodes hosting the decentralized service; maintaining, by the node, in the persistent virtual memory, an instance memory segment that stores variables associated with an instance-level state local to the plurality of nodes, the instance memory segment being private to the node and not synchronized among other nodes in the plurality of nodes; and dynamically loading, by the node, one or more memory pages from a non-volatile storage system into the persistent virtual memory in response to one or more access requests, wherein the loaded memory pages correspond to a portion of the service-level state or instance-level state for processing the access requests.
Clause 22. The computer-implemented method of clause 21, wherein each memory page in the one or more memory pages is stored in a key-value format within the non-volatile storage system, a key in a key-value format for a memory page being a memory-page identifier of the memory page and a value in the key-value format for the memory page being page content of the memory page or one or more segments of the page content.
Clause 23. The computer-implemented method of clause 21 or 22, wherein the persistent virtual memory is implemented via a user-space paging mechanism, the user-space paging mechanism loading one or more memory pages from the nonvolatile storage system into the persistent virtual memory in response to a page-access request generated by the decentralized service.
Clause 24. The computer-implemented method of any of clauses 21-23, further comprising: allocating, by a memory allocator, address space within the persistent virtual memory for the shared and instance memory segments using a memory allocator; storing metadata associated with the memory allocator in the non-volatile storage system, the metadata comprising state information associated with the memory allocator and variable-reference information identifying memory locations associated with one or more allocated objects; and maintaining continuity of virtual-memory addressing across successive executions of the decentralized service by reloading the stored allocator metadata and variable-reference information during subsequent executions.
Clause 25. The computer-implemented method of any of clauses 21-24, wherein the persistent virtual memory maintains versioned service-state information within the shared memory segment, each version corresponding to a recorded state of the decentralized service and enabling deterministic verification and rollback recovery.
Clause 26. The computer-implemented method of any of clauses 21-25, further comprising restoring a prior version of the service-level state by re-loading previously persisted memory pages associated with the prior version into the persistent virtual memory.
Clause 27. The computer-implemented method of any of clauses 21-26, further comprising: obtaining, by the node, verification data representing previously persisted memory pages of the shared memory segment from one or more archival nodes of the decentralized computing platform; verifying consistency of the shared memory segment based on a comparison between locally stored memory pages and the verification data; and committing, by the node, updated memory pages to the non-volatile storage system responsive to a successful verification.
Clause 28. The computer-implemented method of any of clauses 21-27, wherein at least one of the plurality of nodes is implemented on a mobile device or an Internet-of-Things (IoT) device that executes the decentralized service using the persistent virtual memory subsystem without specialized execution hardware.
Clause 29. In some embodiments, a system comprises one or more processors; and one or more memory devices storing instructions that, when executed by the one or more processors, cause the system to: execute, by a node of a plurality of nodes, operations of one or more decentralized services within a virtual execution environment instantiated across the plurality of nodes; maintain, by the node, in a persistent virtual memory, a shared memory segment that stores one or more variables associated with a service-level state of at least one decentralized service, the shared memory segment is synchronized among a subset of the plurality of nodes hosting the decentralized service; maintain, by the node, in the persistent virtual memory, an instance memory segment that stores variables associated with an instance-level state local to the plurality of nodes, the instance memory segment being private to the node and not synchronized among other nodes in the plurality of nodes; and dynamically load, by the node, one or more memory pages from a non-volatile storage system into the persistent virtual memory in response to one or more access requests, wherein the loaded memory pages correspond to a portion of the service-level state or instance-level state for processing the access requests.
Clause 30. The system of clause 29, wherein each memory page in the one or more memory pages is stored in a key-value format within the non-volatile storage system, a key in a key-value format for a memory page being a memory-page identifier of the memory page and a value in the key-value format for the memory page being page content of the memory page or one or more segments of the page content.
Clause 31. The system of clause 29 or 30, wherein the persistent virtual memory is implemented via a user-space paging mechanism, the user-space paging mechanism loading one or more memory pages from the nonvolatile storage system into the persistent virtual memory in response to a page-access request generated by the decentralized service.
Clause 32. The system of any of clauses 29-31, wherein the instructions further cause the system to: allocate, by a memory allocator, address space within the persistent virtual memory for the shared and instance memory segments using a memory allocator; store metadata associated with the memory allocator in the non-volatile storage system, the metadata comprising state information associated with the memory allocator and variable-reference information identifying memory locations associated with one or more allocated objects; and maintain continuity of virtual-memory addressing across successive executions of the decentralized service by reloading the stored allocator metadata and variable-reference information during subsequent executions.
Clause 33. The system of any of clauses 29-32, wherein the persistent virtual memory maintains versioned service-state information within the shared memory segment, each version corresponding to a recorded state of the decentralized service and enabling deterministic verification and rollback recovery.
Clause 34. The system of any of clauses 29-33, wherein the instructions further cause the system to: restore a prior version of the service-level state by re-loading previously persisted memory pages associated with the prior version into the persistent virtual memory.
Clause 35. The system of any of clauses 29-34, wherein the instructions further cause the system to: obtain, by the node, verification data representing previously persisted memory pages of the shared memory segment from one or more archival nodes of the decentralized computing platform; verify consistency of the shared memory segment based on a comparison between locally stored memory pages and the verification data; and commit, by the node, updated memory pages to the non-volatile storage system responsive to a successful verification.
Clause 36. The system of any of clauses 29-35, wherein at least one of the plurality of nodes is implemented on a mobile device or an Internet-of-Things (IOT) device that executes the decentralized service using the persistent virtual memory subsystem without specialized execution hardware.
Clause 37. In some embodiments, a non-transitory computer-readable medium stores instructions that, when executed by one or more processors, cause the processors to perform operations comprising: executing, by a node of a plurality of nodes, operations of one or more decentralized services within a virtual execution environment instantiated across the plurality of nodes; maintaining, by the node, in a persistent virtual memory, a shared memory segment that stores one or more variables associated with a service-level state of at least one decentralized service, the shared memory segment is synchronized among a subset of the plurality of nodes hosting the decentralized service; maintaining, by the node, in the persistent virtual memory, an instance memory segment that stores variables associated with an instance-level state local to the plurality of nodes, the instance memory segment being private to the node and not synchronized among other nodes in the plurality of nodes; and dynamically loading, by the node, one or more memory pages from a non-volatile storage system into the persistent virtual memory in response to one or more access requests, wherein the loaded memory pages correspond to a portion of the service-level state or instance-level state for processing the access requests.
Clause 38. The non-transitory computer-readable medium of clause 37, wherein each memory page in the one or more memory pages is stored in a key-value format within the non-volatile storage system, a key in a key-value format for a memory page being a memory-page identifier of the memory page and a value in the key-value format for the memory page being page content of the memory page or one or more segments of the page content.
Clause 39. The non-transitory computer-readable medium of clause 37 or 38, wherein the persistent virtual memory is implemented via a user-space paging mechanism, the user-space paging mechanism loading one or more memory pages from the nonvolatile storage system into the persistent virtual memory in response to a page-access request generated by the decentralized service.
Clause 40. The non-transitory computer-readable medium of any of clauses 37-39, wherein the operations further comprise: allocating, by a memory allocator, address space within the persistent virtual memory for the shared and instance memory segments using a memory allocator; storing metadata associated with the memory allocator in the non-volatile storage system, the metadata comprising state information associated with the memory allocator and variable-reference information identifying memory locations associated with one or more allocated objects; and maintaining continuity of virtual-memory addressing across successive executions of the decentralized service by reloading the stored allocator metadata and variable-reference information during subsequent executions.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or example language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as example forms of implementing the claims.

What is claimed is:

1. A computer-implemented method comprising:
executing, by a node of a plurality of nodes, operations of one or more decentralized services within a virtual execution environment instantiated across the plurality of nodes;
maintaining, by the node, in a persistent virtual memory, a shared memory segment that stores one or more variables associated with a service-level state of at least one decentralized service, the shared memory segment is synchronized among a subset of the plurality of nodes hosting the decentralized service;
maintaining, by the node, in the persistent virtual memory, an instance memory segment that stores variables associated with an instance-level state local to the plurality of nodes, the instance memory segment being private to the node and not synchronized among other nodes in the plurality of nodes; and
dynamically loading, by the node, one or more memory pages from a non-volatile storage system into the persistent virtual memory in response to one or more access requests, wherein the loaded memory pages correspond to a portion of the service-level state or instance-level state for processing the access requests.

2. The computer-implemented method of claim 1, wherein each memory page in the one or more memory pages is stored in a key-value format within the non-volatile storage system, a key in a key-value format for a memory page being a memory-page identifier of the memory page and a value in the key-value format for the memory page being page content of the memory page or one or more segments of the page content.

3. The computer-implemented method of claim 1, wherein the persistent virtual memory is implemented via a user-space paging mechanism, the user-space paging mechanism loading one or more memory pages from the nonvolatile storage system into the persistent virtual memory in response to a page-access request generated by the decentralized service.

4. The computer-implemented method of claim 1, further comprising:
allocating, by a memory allocator, address space within the persistent virtual memory for the shared and instance memory segments using a memory allocator;
storing metadata associated with the memory allocator in the non-volatile storage system, the metadata comprising state information associated with the memory allocator and variable-reference information identifying memory locations associated with one or more allocated objects; and
maintaining continuity of virtual-memory addressing across successive executions of the decentralized service by reloading the stored allocator metadata and variable-reference information during subsequent executions.

5. The computer-implemented method of claim 1, wherein the persistent virtual memory maintains versioned service-state information within the shared memory segment, each version corresponding to a recorded state of the decentralized service and enabling deterministic verification and rollback recovery.

6. The computer-implemented method of claim 5, further comprising restoring a prior version of the service-level state by re-loading previously persisted memory pages associated with the prior version into the persistent virtual memory.

7. The computer-implemented method of claim 1, further comprising:
obtaining, by the node, verification data representing previously persisted memory pages of the shared memory segment from one or more archival nodes of the decentralized computing platform;
verifying consistency of the shared memory segment based on a comparison between locally stored memory pages and the verification data; and
committing, by the node, updated memory pages to the non-volatile storage system responsive to a successful verification.

8. The computer-implemented method of claim 1, wherein at least one of the plurality of nodes is implemented on a mobile device or an Internet-of-Things (IoT) device that executes the decentralized service using the persistent virtual memory subsystem without specialized execution hardware.

9. A system, comprising:
one or more processors; and
one or more memory devices storing instructions that, when executed by the one or more processors, cause the system to:
execute, by a node of a plurality of nodes, operations of one or more decentralized services within a virtual execution environment instantiated across the plurality of nodes;
maintain, by the node, in a persistent virtual memory, a shared memory segment that stores one or more variables associated with a service-level state of at least one decentralized service, the shared memory segment is synchronized among a subset of the plurality of nodes hosting the decentralized service;
maintain, by the node, in the persistent virtual memory, an instance memory segment that stores variables associated with an instance-level state local to the plurality of nodes, the instance memory segment being private to the node and not synchronized among other nodes in the plurality of nodes; and
dynamically load, by the node, one or more memory pages from a non-volatile storage system into the persistent virtual memory in response to one or more access requests, wherein the loaded memory pages correspond to a portion of the service-level state or instance-level state for processing the access requests.

10. The system of claim 9, wherein each memory page in the one or more memory pages is stored in a key-value format within the non-volatile storage system, a key in a key-value format for a memory page being a memory-page identifier of the memory page and a value in the key-value format for the memory page being page content of the memory page or one or more segments of the page content.

11. The system of claim 9, wherein the persistent virtual memory is implemented via a user-space paging mechanism, the user-space paging mechanism loading one or more memory pages from the nonvolatile storage system into the persistent virtual memory in response to a page-access request generated by the decentralized service.

12. The system of claim 9, wherein the instructions further cause the system to:
allocate, by a memory allocator, address space within the persistent virtual memory for the shared and instance memory segments using a memory allocator;
store metadata associated with the memory allocator in the non-volatile storage system, the metadata comprising state information associated with the memory allocator and variable-reference information identifying memory locations associated with one or more allocated objects; and
maintain continuity of virtual-memory addressing across successive executions of the decentralized service by reloading the stored allocator metadata and variable-reference information during subsequent executions.

13. The system of claim 9, wherein the persistent virtual memory maintains versioned service-state information within the shared memory segment, each version corresponding to a recorded state of the decentralized service and enabling deterministic verification and rollback recovery.

14. The system of claim 13, wherein the instructions further cause the system to:
restore a prior version of the service-level state by re-loading previously persisted memory pages associated with the prior version into the persistent virtual memory.

15. The system of claim 9, wherein the instructions further cause the system to:
obtain, by the node, verification data representing previously persisted memory pages of the shared memory segment from one or more archival nodes of the decentralized computing platform;
verify consistency of the shared memory segment based on a comparison between locally stored memory pages and the verification data; and
commit, by the node, updated memory pages to the non-volatile storage system responsive to a successful verification.

16. The system of claim 9, wherein at least one of the plurality of nodes is implemented on a mobile device or an Internet-of-Things (IoT) device that executes the decentralized service using the persistent virtual memory subsystem without specialized execution hardware.

17. A non-transitory computer-readable medium storing instructions that, when executed by one or more processors, cause the processors to perform operations comprising:
executing, by a node of a plurality of nodes, operations of one or more decentralized services within a virtual execution environment instantiated across the plurality of nodes;
maintaining, by the node, in a persistent virtual memory, a shared memory segment that stores one or more variables associated with a service-level state of at least one decentralized service, the shared memory segment is synchronized among a subset of the plurality of nodes hosting the decentralized service;
maintaining, by the node, in the persistent virtual memory, an instance memory segment that stores variables associated with an instance-level state local to the plurality of nodes, the instance memory segment being private to the node and not synchronized among other nodes in the plurality of nodes; and
dynamically loading, by the node, one or more memory pages from a non-volatile storage system into the persistent virtual memory in response to one or more access requests, wherein the loaded memory pages correspond to a portion of the service-level state or instance-level state for processing the access requests.

18. The non-transitory computer-readable medium of claim 17, wherein each memory page in the one or more memory pages is stored in a key-value format within the non-volatile storage system, a key in a key-value format for a memory page being a memory-page identifier of the memory page and a value in the key-value format for the memory page being page content of the memory page or one or more segments of the page content.

19. The non-transitory computer-readable medium of claim 17, wherein the persistent virtual memory is implemented via a user-space paging mechanism, the user-space paging mechanism loading one or more memory pages from the nonvolatile storage system into the persistent virtual memory in response to a page-access request generated by the decentralized service.

20. The non-transitory computer-readable medium of claim 17, wherein the operations further comprise:
allocating, by a memory allocator, address space within the persistent virtual memory for the shared and instance memory segments using a memory allocator;
storing metadata associated with the memory allocator in the non-volatile storage system, the metadata comprising state information associated with the memory allocator and variable-reference information identifying memory locations associated with one or more allocated objects; and
maintaining continuity of virtual-memory addressing across successive executions of the decentralized service by reloading the stored allocator metadata and variable-reference information during subsequent executions.
